(19) United States
(12) Patent Application Publication
(10) Pub. No.: US 2022/0327933 A1
(43) Pub. Date: Oct. 13, 2022

(54) INTELLIGENTLY GENERATING COMPUTER MODEL LEARNING DATA BY DISPATCHING ENHANCED SENSORY VEHICLES UTILIZING DATA COLLECTION VALUES

(71) Applicant: Lyft, Inc., San Francisco, CA (US)

(72) Inventors: Guy-Baptiste Richard de Capele d'Hautpoul, San Francisco, CA (US); Emilie Jeanne Anne Danna, Sunnyvale, CA (US)

(21) Appl. No.: 17/229,690

(22) Filed: Apr. 13, 2021

(51) Int. Cl. G08G 1/00; B60W 60/00; G01C 21/34

(52) U.S. Cl. CPC G08G 1/202; G08G 1/207; B60W 60/00253; G01C 21/3492

(57) ABSTRACT

The present disclosure relates to systems, non-transitory computer-readable media, and methods for determining data collection values for enhanced sensor provider vehicles in a provider vehicle pool and utilizing the data collection values to select and dispatch a provider vehicle for a transportation request. In particular, in one or more embodiments, the disclosed systems determine data collection values based on various route features for a particular enhanced sensor provider vehicle. Additionally, in one or more embodiments, the disclosed systems can utilize the data collection values in conjunction with a device matching algorithm and transportation values to select and dispatch a provider vehicle. Further, in some embodiments, the disclosed systems utilize collected sensory data to train one or more computer implemented machine learning models, such as an autonomous vehicle driving model.

### BACKGROUND

Recent years have seen significant development in transportation systems that utilize web and mobile applications to match provider devices to real-time on-demand transportation requests from requestor devices. For example, on-demand transportation systems can match provider devices with requestor devices to provide transportation services for thousands of requestor devices distributed across a wide geographical area. Although transportation systems can match multiple requestors with providers, such systems suffer from a number of technical problems, particularly in accuracy, efficiency, and flexibility of implementing computer systems.

### BRIEF SUMMARY

Embodiments of the present disclosure provide benefits and/or solve one or more of the foregoing or other problems in the art with systems, non-transitory computer-readable media, and methods for dynamically generating learning data for computer implemented models by intelligently dispatching enhanced sensor provider vehicles utilizing data collection values. More specifically, in one or more embodiments, the transportation matching system utilizes route features corresponding to a digital transportation request to determine a data collection value for each enhanced sensor provider vehicle in a vehicle pool. To illustrate, in one or more embodiments, the transportation matching system utilizes geofencing and previously collected data to determine priority of a route, time of day, and/or road classification to determine data collection values. In one or more embodiments, the transportation matching system utilizes data collection values to determine transportation values for dispatching enhanced sensor provider vehicles, servicing digital transportation requests, and/ determining routes of enhanced sensor provider vehicles. Further, in one or more embodiments, the transportation matching system utilizes collected sensory data to train or support one or more computer implemented models such as an autonomous vehicle driving model. In this manner, the disclosed systems can efficiently and flexibly gather precise data volumes utilizing enhanced sensor provider vehicles and generate more accurate machine learning models.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a transportation matching system can operate in accordance with one or more embodiments.

FIG. 2 illustrates an overview of a process for selecting an enhanced sensor provider device from a provider device pool based on data collection values.

FIG. 3 illustrates diagram of generating and utilizing data collection values in accordance with one or more embodiments.

FIG. 4A illustrates a flow diagram for generating modified routes based on data collection values in accordance with one or more embodiments.

FIG. 4B illustrates a diagram for assigning a provider device to a digital transportation request based on data collection values and transportation values in accordance with one or more embodiments.

FIG. 5 illustrates a diagram for determining a relocation for a provider device in accordance with one or more embodiments.

FIG. 6 illustrates a flowchart for training an autonomous vehicle driving model utilizing collected sensory data in accordance with one or more embodiments.

FIG. 7 illustrates a schematic diagram of a transportation matching system in accordance with one or more embodiments.

FIG. 8 illustrates a flowchart of a series of acts for dispatching a provider device based on a data collection value in accordance with one or more embodiments.

FIG. 9 illustrates a block diagram of an example computing device for implementing one or more embodiments of the present disclosure.

FIG. 10 illustrates an example network environment of a transportation matching system in accordance with one or more embodiments.

### DETAILED DESCRIPTION

This disclosure describes one or more embodiments of a transportation matching system that dynamically generates learning data for computer-implemented models by intelligently dispatching enhanced sensor provider vehicles from a pool of provider vehicles utilizing data collection values. In particular, the transportation matching system can match enhanced sensor provider vehicles to transportation requests, dispatch enhanced sensor provider vehicles to more efficient locations, and/or select unique routes specific to enhanced sensor provider vehicles based on improved data collection values reflecting the priority of extra-sensory information that can be obtained utilizing the enhanced sensor provider vehicles. In this manner, the transportation matching system can efficiently and flexibly dispatch enhanced sensor provider vehicles to gather precise training data volumes for computer implemented models, such as autonomous vehicle driving models.

To illustrate, in one or more embodiments, the transportation matching system utilizes route features and geofence information to determine data collection values reflecting a score for the value of collecting sensory data along a route. In one or more embodiments, the transportation matching system assigns provider devices to digital transportation requests by utilizing a data collection value to determine transportation values for each provider device in a pool of available provider devices. Additionally, in some embodiments, the transportation matching system utilizes the data collection values to relocate enhanced sensor provider vehicles to more efficient locales. The transportation matching system can also utilize data collection values to determine alternate routes for digital transportation requests with improved efficiency with regard to collecting sensory data.

As mentioned, the transportation matching system can dispatch and manage a fleet of provider vehicles that includes enhanced sensor provider vehicles. Thus, for example, the transportation matching system can equip a subset of vehicles within a fleet with extra-sensory devices to collect particular types of digital information. For example, in some embodiments, enhanced sensor provider vehicles include external cameras, LIDAR sensors, RADAR sensors, motion detectors, inertial measurement units, accelerometers, and/or GPS. The transportation matching system can efficiently manage a fleet of vehicles that includes a subset of these enhanced sensor provider vehicles and other vehicles not equipped with the same sensory capabilities.

In one or more embodiments, the transportation matching system determines data collection values for regions, locations, or routes corresponding to enhanced sensor provider vehicles. To illustrate, the transportation matching system can determine routes corresponding to different provider devices for a particular digital transportation request. Further, in one or more embodiments, the transportation matching system determines route features of the routes. For example, the transportation matching system can determine route locations, directionality of the route at route locations, time of day for servicing the digital transportation request, and/or prioritized road classifications. The transportation matching system can utilize each of these route features to determine data collection values for an enhanced sensor provider vehicle in traversing the route.

For example, the transportation matching system can generate geofences corresponding to prioritized regions for data collection. In some embodiments, the transportation matching system identifies portions of a route that are within a geofence. Accordingly, the transportation matching system can determine a portion of a route within a geofence and (based on a priority of the geofence) determine a data collection value for the portion of the route within the geofence. Thus, the transportation matching system can utilize the geofence information for the route to determine route features and, accordingly, the corresponding data collection value.

Further, the transportation matching system can utilize the data collection values to determine transportation values corresponding to the enhanced sensor provider vehicles. In one or more embodiments, the transportation matching system determines assignment of a digital transportation request to a pool of available provider devices based on relative transportation values. Thus, the transportation matching system can generate transportation values corresponding to enhanced sensor provider vehicles based in part on determined data collection values. In one or more embodiments, the transportation matching system also utilizes predicted wait times, predicted total transportation times, requestor data, and a variety of other factors to determine transportation values. Accordingly, in one or more embodiments, the transportation matching system utilizes transportation values that reflect data collection priorities in selecting a provider device to service a digital transportation request.

In one or more embodiments, the transportation matching system also utilizes data collection values to select routes for provider devices. To illustrate, the transportation matching system utilizes data collection values to determine whether to generate a modified route that improves a data collection value (and corresponding route value). For example, in some embodiments the transportation matching system determines a variety of alternate routes with the same initial and final location. The transportation matching system can select an alternate route that improves the data collection value without significantly impacting an overall route value metric (e.g., a route metric that reflects other factors, such as driver and rider satisfaction, deviation time, and/or deviation distance). For example, the transportation matching system can select an alternate route that improves the data collection value and the overall route value, without significantly impacting deviation (in time or distance thresholds) from an initial route.

In one or more embodiments, the transportation matching system also dispatches enhanced sensor provider vehicles to more efficient locations based on data collection values. More specifically, the transportation matching system can determine a data collection value for a provider device without a digital transportation request. The transportation matching system can utilize the current location of the provider device and historical digital transportation request data to determine a data collection value reflecting the likely value of collecting data in the region of the provider device. Based on this data collection value, the transportation matching system can determine whether to relocate the provider device. Further, in one or more embodiments, the transportation matching system determines a route for relocation of the provider device with an improved data collection value and efficiency.

The transportation matching system can receive, gather, and monitor sensory data from enhanced sensor provider vehicles over the course of various routes. As previously mentioned, the enhanced sensor provider vehicle includes a digital camera and a digital microphone that record images and sounds around the enhanced sensor provider vehicle. In one or more embodiments, the transportation matching system receive collected sensory data directly from a computing device within the enhanced sensor provider vehicle. Additionally, or in the alternative, the transportation matching system can receive collected sensory data via the provider device associated with an enhanced sensor provider vehicle.

In one or more embodiments, the transportation matching system utilizes collected sensory data in building various computer models (e.g., machine learning models). For example, the transportation matching system can utilize collected data in building an autonomous vehicle driving model. To illustrate, the transportation matching system can build an autonomous vehicle driving model including underlying digital maps, driving classification models (e.g., for classifying surrounding objects or events), driving response models (e.g., for determining an appropriate response to surrounding objects or events), and/or a driving prediction models (e.g., for predicting future actions resulting from a current state of a vehicle and its environment).

The transportation matching system can utilize data collection values for a variety of other features. For example, the transportation matching system can utilize data collection values to identify and distribute driver transportation zones with unique value notifications. Similarly, the transportation matching system can utilize data collection values to assign or combine passenger transportation requests (e.g., to assign an enhanced sensory vehicle to multiple different requesting devices based on data collection values associated with routes connecting various locations). Moreover, the transportation matching system can utilize data collection values to modify user interfaces and ride values for requestor devices, to provide various digital incentives to provider devices, or to generate digital schedules for provider devices.

As briefly mentioned above, a number of technical problems exist with conventional transportation systems, particularly in accuracy, efficiency, and flexibility of operation. To illustrate, conventional systems often struggle to obtain accurate learning data for building various computer models. Indeed, conventional systems often generate synthetic training data or attempt to generate heuristic models without training data. This approach often leads to models that are inaccurate and imprecise. For example, machine learning models that power autonomous driving vehicles need significant training data to learn underlying terrain, maps, scenarios, objects, reactions, and circumstances encountered in real-world driving situations. Conventional systems are often unable to generate such training data and thus struggle to generate accurate computer models.

In addition to these accuracy concerns, conventional systems also struggle with inefficiency and inflexibility. Indeed, conventional systems often utilize excessive time and device resources to gather training data for various computer implemented models. To illustrate, some conventional systems purchase separate vehicles, utilize computer models to identify various routes, and then utilize providers and corresponding devices to traverse these routes. This rigid process wastes significant resources of server devices, provider computing devices, and time.

The transportation matching system provides many advantages and benefits over conventional systems and methods. For example, the transportation matching system can improve accuracy of various computer implemented models by gathering precise, accurate training data. Indeed, as mentioned above, the transportation matching system can analyze collected information to determine precise data needs and intelligently generate data collection values corresponding to the particular requirements at any given time or location. The transportation matching system can then dispatch enhanced sensor provider devices to locations, along particular routes, or to particular transportation requests based on these data collection values. Thus, the transportation matching system can accurately obtain training data for specific geographic regions, times, or scenarios. Moreover, the transportation matching system can generate more accurate computer models, such as autonomous vehicle driving models.

In addition, by utilizing data collection values to match provider devices and requestor devices, select routes, and otherwise dispatch provider devices the transportation matching system improves efficiency relative to conventional systems. Specifically, the transportation matching system utilizes data collection values to improve efficiency in servicing digital transportation requests and managing a fleet of provider devices while simultaneously gathering sensory data. To illustrate, the transportation matching system utilizes data collection values to prioritize data collections for particular road types, geofenced areas, and/or uncollected areas. Thus, the transportation matching system conserves resources and eliminates or reduces excess communications by providing navigational instructions that both efficiently service transportation requests and collect prioritized sensory data.

Additionally, the transportation matching system improves flexibility by considering data collection values in dispatching provider devices. Indeed, by utilizing data collection values to assign provider devices to particular transportation requests, the transportation matching system flexibly collects sensory data in high-value scenarios while providing transportation services. Further, the transportation matching system can flexibly select various routes for enhanced sensor provider vehicles to intelligently vary collected data while servicing transportation requests. Moreover, the transportation matching system can flexibly determine new fleet configurations to position enhanced sensor provider vehicles. Accordingly, the transportation matching system better able to flexibly adapt a fleet of provider devices based on both a variety of transportation scenarios and specific data collection needs.

As illustrated by the foregoing discussion, the present disclosure utilizes a variety of terms to describe features and advantages of the transportation matching system. Additional detail is now provided regarding the meaning of such terms. For example, as used herein, the term “provider device” refers to refers to a computing device associated with a transportation provider and/or transportation vehicle, including an enhanced sensor provider vehicle. Similarly, the term “requestor device” refers to a computing device associated with a digital transportation requestor. The transportation matching system can match provider devices to requestor devices and requestor devices to other requestor devices based on a variety of criteria.

Additionally, as used herein, the term “digital transportation request” refers to a request from a requestor device for transportation. In particular, the term “digital transportation request” can include a request received by the transportation matching system from a requestor device for transportation from to a drop-off location from a pick-up location.

Also, as used herein, the term “enhanced sensor provider vehicle” refers to a vehicle associated with a provider device including one or more data collection devices (e.g., a provider vehicle having additional data collection devices relative to other provider vehicles in a pool of provider vehicles). To illustrate, an enhanced sensor provider vehicle can include a provider vehicle with built-in cameras (e.g., cameras affixed to the frame or body to capture images external to the vehicle), microphones, motion sensors, RADAR sensors, LIDAR sensors, GPS, inertial measurement units, accelerometers, etc. In addition, or in the alternative, an enhanced sensor provider vehicle can include a provider device with associated cameras, microphones, motion sensors, etc. attached and/or integrated into the provider vehicle after manufacture.

Further, as used herein, the term “data collection value” refers to a metric reflecting a priority, significance, or benefit of sensory data collection along a route or at a location. In particular, the term “data collection value” can include a metric measuring the value of sensory data that can be collected before, during, or after traversing a route, traveling at a location, or servicing a digital transportation request. To illustrate, the transportation matching system can determine a data collection value based on various route features, such as route locations, directionality of navigation along a route, time of day, prioritized road classification, and/or locations relative to a geofence.

Additionally, as used herein, the term “sensory data” refers to information captured during navigation of a vehicle. In particular, the term “sensory data” can include photos, videos, audio, motion data, proximity sensor data, LIDAR data, RADAR data, GPS data, and/or other information. To illustrate, sensory data can include information captured by an enhanced sensory provider vehicle and/or a provider device during navigation along a route for a transportation matching system.

Further, as used herein, the term “autonomous vehicle driving model” refers to a computer implemented model for operating autonomous (e.g., self-driving) vehicles. For example, the term “autonomous vehicle driving model” can include a mapping model, a driving classification model for classifying objects and events during navigation of an autonomous vehicle, a driving response model for generating responses to information during navigation of an autonomous vehicle, and/or a driving prediction model for predicting consequences (e.g. future actions) for various actors observed during navigation of an autonomous vehicle. To illustrate, an autonomous vehicle driving model can include a system that dynamically navigates an autonomous vehicle. In one or more embodiments, an autonomous vehicle driving model is trained or built utilizing collected sensory data.

Also, as used herein, the term “data collection geofence” refers to a geographic area corresponding to data collection. In particular, a data collection geofence can include a virtual perimeter associated with a priority for sensory data collection. In one or more embodiments, the transportation matching system determines route locations within a collection geofence in order to determine a data collection value for a route.

Additionally, as used herein, the term “prioritized road classification” refers to a road category or class for sensory data collection. In particular, the term “prioritized road classification” can include a particular road type (e.g. highway, surface street, etc.), an intersection type (e.g. 4-way stop, streetlight, etc.), and/or a zoning type (e.g. residential, commercial, etc.). In one or more embodiments, the transportation matching system utilizes prioritized road classification of route locations to determine a data collection value for a route.

Further, as used herein, the term “transportation value” refers to a metric measuring the value, priority, significance, or benefit of a transportation match between a provider device and a requestor device. In particular, the term “transportation value” can include a metric reflecting the overall value for assigning a particular provider device to a route or digital transportation request. To illustrate, in one or more embodiments, the transportation matching system determines transportation values based on data collection values, wait times, idle times, total transportation times, requestor data, and a variety of other factors relative to a digital transportation request.

Also, as used herein, the term “threshold value” (or “collection value threshold”) refers to a requisite value to perform a particular action. In particular, a threshold value can include a requisite data collection value or transportation value to assign a transportation request to an enhanced sensor provider vehicle.

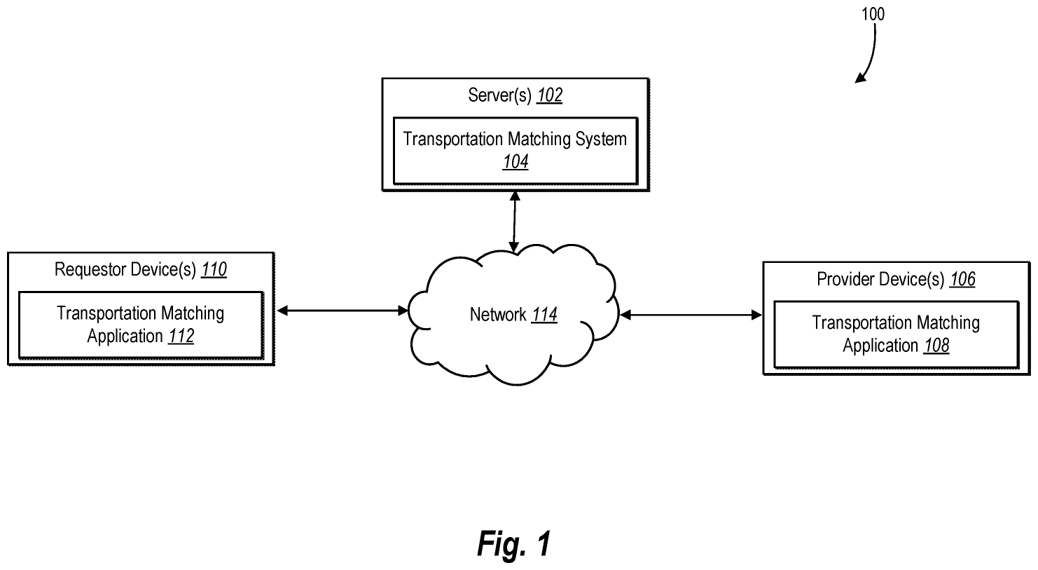

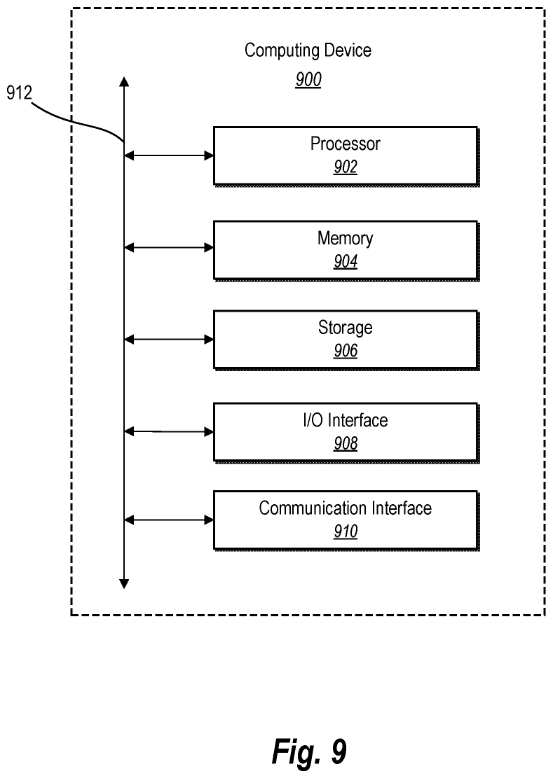

Additional detail will now be provided in relation to illustrative figures portraying example embodiments and implementations of the transportation matching system. For example, FIG. 1 illustrates a computing system environment (or “system”) 100 for implementing a transportation matching system in accordance with one or more embodiments. As shown in FIG. 1, the system 100 includes server(s) 102, a transportation matching system 104, provider device(s) 106, requestor device(s) 110, and a network 114. Each of the components of the system 100 can communicate via the network 114, and the network 114 may be a variety of suitable networks over which computing devices can communicate. Example networks are discussed in more detail below in relation to FIG. 9.

As shown in FIG. 1, the system 100 includes the provider device(s) 106 and the requestor device(s) 110. The provider device(s) 106 and the requestor device(s) 110 can each be one of a variety of computing devices, including a smartphone, tablet, smart watch, smart television, desktop computer, laptop computer, virtual reality device, augmented reality device, or other computing device as described in relation to FIG. 9. In addition, the provider device(s) 106 and the requestor device(s) 110 can further communicate with the server(s) 102, including the transportation matching system 104, via the network 114.

For example, in response to digital transportation requests from the requestor device(s) 110, the transportation matching system 104 can communicate with the provider device(s) 106 and/or the requestor device(s) 110 via the network 114 to provide various communications. For example, the transportation matching system 104 can match the provider device(s) 106 and the requestor device(s) 110 for providing transportation services. Moreover, as discussed above, the transportation matching system 104 provides navigational instructions to the provider device(s) 106 via the network 114. Additionally, the provider device(s) 106 can send collected sensory data, including from an enhanced sensory vehicle, to the server(s) 102 and the transportation matching system 104 via the network 114.

In one or more embodiments, the provider device(s) 106 and the requestor devices 110 correspond to one or more user accounts (e.g., user accounts stored at the server(s) 108). For example, a user of a provider device can establish a user account with login credentials and a provider of the provider device can establish a provider account with login credentials. The transportation matching system 104 can manage provider device(s) 106 and the requestor device(s) 110 based on appropriate privileges associated with the corresponding user accounts (e.g. provider accounts and/or requestor accounts). Accordingly, providers and/or requestors can utilize multiple devices (e.g., multiple provider devices or multiple requestor devices) with the appropriate privileges associated with the corresponding accounts. The present disclosure utilizes provider devices and requestor devices to refer to devices associated with these user accounts. Thus, in referring to a provider device or a requestor device, the disclosure and the claims are not limited to communications with a specific device, but any device corresponding to an account of a particular user. Accordingly, in using the term provider device, this disclosure refers to any computing device corresponding to a provider account. Similarly, in using the term requestor device, this disclosure refers to any computing device corresponding to a requestor account.

As shown, the provider device(s) 106 and the requestor device(s) 110 include corresponding transportation matching applications 108 and 112, respectively. In particular, the transportation matching applications 108,112 may be a web application, a native application installed on the provider device(s) 106 and the requestor device(s) 110 (e.g., a mobile application, a desktop application, etc.), or a cloud-based application where part of the functionality is performed by the server(s) 102. The transportation matching application 108 and the transportation matching application 112 can present or display information to users respectively associated with the provider device(s) 106 and the requestor device(s) 110, including requestor device matches, provider device matches, incentive information, etc. As an example, the transportation matching application 108 can cause the provider device(s) 106 to communicate with the transportation matching system 104 based on received provider selection of an option to provide transportation services.

As illustrated in FIG. 1, the system 100 includes the server(s) 102. The server(s) 102 may execute, generate, store, receive, and transmit electronic data, such as executable instructions for generating data collection values and/or selecting provider devices to service digital transportation requests. For example, the server(s) 102 may receive digital transportation requests from the requestor device(s) 110. In turn, the server(s) 102 can transmit data associated with the digital transportation requests to one or more components in the system 100. In one or more embodiments, the server(s) 102 can provide notifications of requestor device matching and provider device matching to the requestor device(s) 110 and/or the provider device(s) 106.

Although FIG. 1 depicts the transportation matching system 104 located on the server(s) 102, in some embodiments, the transportation matching system 104 may be implemented by one or more other components of the system 100 (e.g., by being implemented entirely or in part at one or more of the other components). For example, the transportation matching system 104 may be implemented in whole, or in part, by the provider device(s) 106 and/or the requestor device(s) 110. Additionally, although not illustrated in FIG. 1, in some embodiments, the system 100 may have a different arrangement of components and/or may have a different number or set of components altogether.

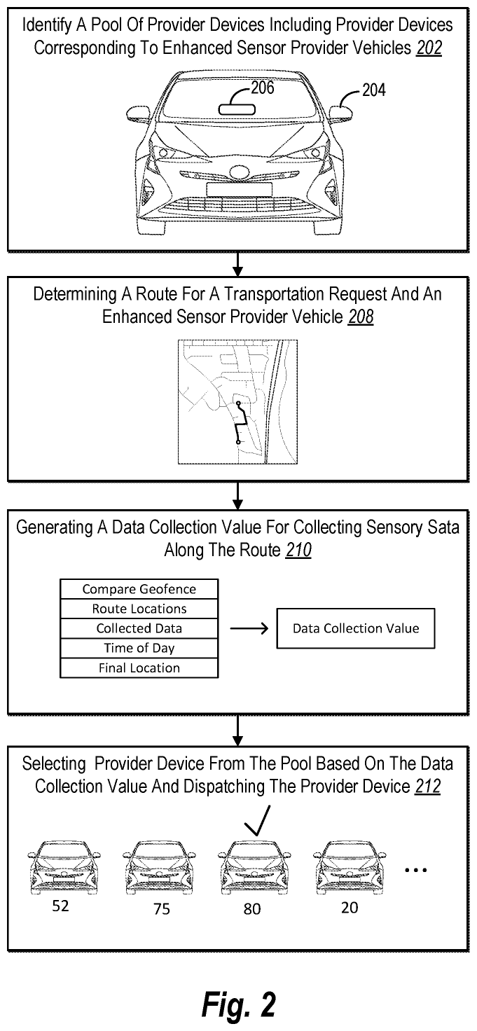

As mentioned above, in one or more embodiments, the transportation matching system 104 generates data collection values and utilizes the data collection values to select a provider device (and/or corresponding transportation route) from a pool of available provider devices. FIG. 2 illustrates an overview of the process for generating and utilizing data collection values to select a provider device to match with a transportation request. To illustrate, as shown in FIG. 2, the transportation matching system 104 performs an act 202 of identifying a pool of provider devices (e.g., a pool of vehicles) including provider devices corresponding to enhanced sensor provider vehicles. In one or more embodiments, the transportation matching system 104 identifies provider devices within a geographical proximity to a requestor device that are both active and unassigned (or predicted to become unassigned prior to the transportation request being serviced) to identify the pool of available provider devices.

The transportation matching system 104 can also identify provider devices in the pool of available provider devices that correspond to enhanced sensor provider vehicles. FIG. 2 illustrates an enhanced sensor provider vehicle 204 with enhanced sensors 206. The enhanced sensors can include cameras, microphones, motion sensors, proximity sensors, LIDAR, RADAR, speedometers, GPS sensors, and/or other sensors at various positions on the enhanced sensor provider vehicle 204. In one or more embodiments, the enhanced sensors 206 are built-in to the enhanced sensor provider vehicle.

In one or more embodiments, the transportation matching system 104 receives sensory data collected by the enhanced sensors 206 on the enhanced sensor provider vehicle 204. To illustrate, in one or more embodiments, the transportation matching system 104 receives the sensory data directly from the enhanced sensor provider vehicle 204. In addition, or in the alternative, the transportation matching system 104 can receive sensory data from the provider device associated with the enhanced sensor provider vehicle 204. To illustrate, in one or more embodiments, the enhanced sensor provider vehicle 204 can communicate the sensory data to the provider device (e.g., a smartphone), which can in turn provide the sensory data to the enhanced sensor provider vehicle 204.

The provider device can also provide sensory data to the transportation matching system 104 collected by the provider device itself. To illustrate, the provider device can itself include cameras, microphones, motion sensors, proximity sensors, speedometers, GPS sensors, and/or other sensors. In one or more embodiments, the provider device can attach to the enhanced sensor provider vehicle 204 for sensory data collection. The provider device can provide this sensory data to the transportation matching system 104 in addition to any sensory data collected by the enhanced sensor provider vehicle 204.

Additionally, as shown in FIG. 2, the transportation matching system 104 performs an act 208 of determining a route for a digital transportation request and an enhanced sensor provider vehicle. To illustrate, the transportation matching system 104 generates a route that the enhanced sensor provider vehicle would take if it were to service a received digital transportation request. More specifically, the transportation matching system 104 generates a route for the enhanced sensor provider vehicle from its current location to the pick-up location of the digital transportation request. Additionally, the transportation matching system 104 generates a route for servicing the digital transportation request.

Further, in one or more embodiments, the transportation matching system 104 performs an act 210 of generating a data collection value for collecting sensory data along the route. In one or more embodiments, the transportation matching system 104 determines various route features to determine a data collection value. For example, as shown in FIG. 2, the transportation matching system 104 can utilize a geofence, determine route locations, evaluate previously collected data, determine time of day for the route, and evaluate the final location of the route.

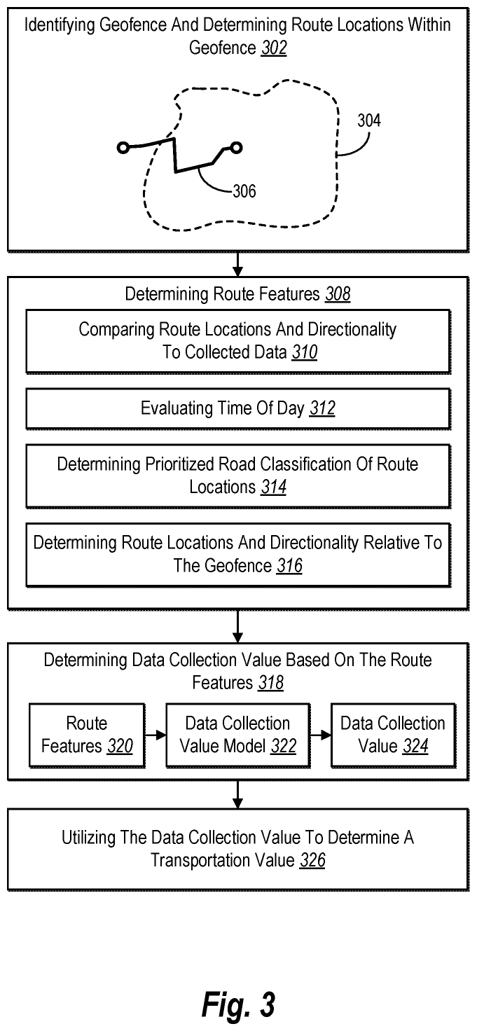

The transportation matching system 104 can utilize these various features of the route to determine a data collection value for the route reflecting the value of data collected during the route to the transportation matching system 104. As will be discussed in greater detail below with regard to FIG. 3, the transportation matching system 104 can utilize a data collection value model to determine data collection values. In addition, or in the alternative, the transportation matching system 104 can score and weight various route features to determine the data collection value.

As also shown in FIG. 2, the transportation matching system 104 can perform an act 212 of selecting a provider device from the pool based on the data collection value and dispatching the provider device. In one or more embodiments, the transportation matching system 104 determines transportation values for provider devices associated with enhanced sensor provider vehicles utilizing data collection values. The transportation matching system 104 can further utilize various other factors, such as wait times, idle times, requestor characteristics, etc.

As shown in FIG. 2, the transportation matching system 104 compares transportation values among different provider devices in the pool of available provider devices in order to select a provider device to service the digital transportation request. More specifically, the transportation matching system 104 determines data collection values for each enhanced sensor provider vehicle associated with a provider device in a pool of available provider devices. Then, the transportation matching system 104 determines a transportation value for each provider device in the pool of available provider devices (i.e. for both enhanced sensor provider vehicles and non-enhanced sensor provider vehicles). For enhanced sensor provider vehicles, the transportation matching system 104 utilizes the data collection value to determine the transportation value.

Thus, the transportation matching system 104 can compare each provider device in a provider device pool based on the transportation values. The transportation values for enhanced sensor provider vehicles incorporate the data collection value, which enables the transportation matching system 104 to compare enhanced sensor provider vehicles and non-enhanced sensor provider vehicles while taking into account data collection value. In one or more embodiments, the transportation matching system 104 assigns the transportation request to the provider device associated with the highest transportation value.

Although FIG. 2 illustrates a particular approach utilizes the transportation matching system 104 in one or more embodiments, the transportation matching system 104 can utilize data collection values in a variety of processes to dispatch provider devices.

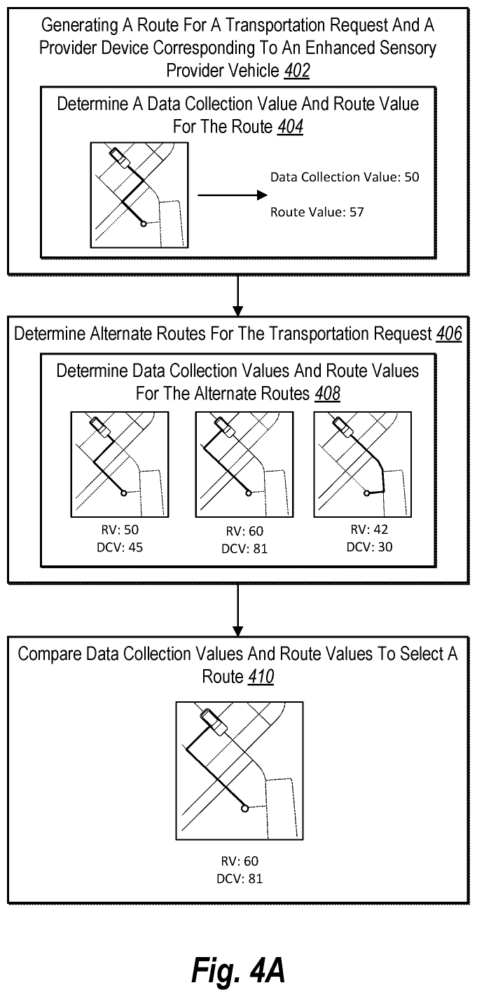

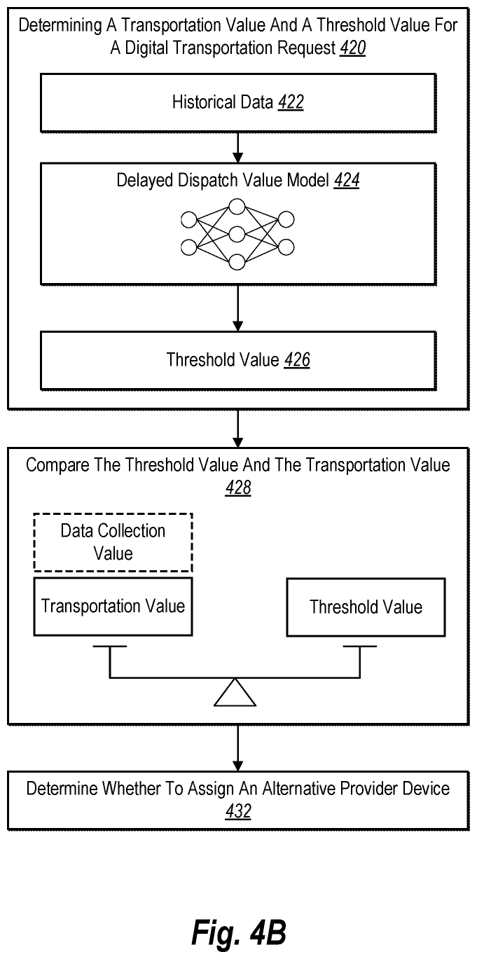

For example, in one or more embodiments, the transportation matching system 104 can utilize data collection values to modify a route for a provider device. Indeed, the transportation matching system can analyze data collection values (before or after assigning an enhanced sensor provider vehicle) select or modify a route for the transportation request. To illustrate, as will be discussed in greater detail with regard to FIG. 4A, in some embodiments, the transportation matching system 104 determines alternate routes for a transportation request. The transportation matching system 104 can determine data collection values for various routes. The transportation matching system 104 can also utilize the data collection values and other factors (e.g., deviation metrics) to determine route values for the various routes. The transportation matching system 104 can then compare the route values to select and/or modify a route for a particular transportation request (or other dispatch).

Similarly, in some embodiments, the transportation matching system 104 can select a provider device vehicle without enhanced sensory capabilities to service a transportation request (even if the enhanced sensor provider vehicle has the highest transportation value). As discussed below (e.g., in relation to FIG. 4B), the transportation matching system 104 can analyze a threshold value (e.g., based on anticipated values of future transportation requests) and determine that a given transportation request fails to satisfy the threshold value. Thus, in some embodiments, the transportation matching system 104 analyzes a predicted data collection value of future transportation requests for an enhanced sensor provider vehicle and selects a provider devices based on this predicted data collection value.

Moreover, in one or more embodiments, the transportation matching system 104 determines to dispatch drivers based on data collection value of the provider device at its current location and/or alternate locations. For example, if the transportation matching system 104 determines that a provider device is at a particular location, the transportation matching system 104 can determine historical data to determine the value (including data collection value) of a provider device at that location. To illustrate, the transportation matching system 104 determines the value of likely future transportation requests (and corresponding data collection values) that may be assigned to the provider device based on the provider device being at that location.

Further, in one or more embodiments, the transportation matching system 104 utilizes historical data to determine values (including data collection value) of a provider device at various alternative locations. Accordingly, as will be discussed in greater detail below with regard to FIG, 5, in one or more embodiments, the transportation matching system 104 determines the highest value and determines to relocate the provider device. In some embodiments, the transportation matching system 104 utilizes determinations of historical values and determinations of relocation as described by Sebastien Jean Francois Martin et al., Dispatching Provider Devices Utilizing Multi-Outcome Transportation-Value Metrics And Dynamic Provider Device Modes, U.S. application Ser. No. 16/985,650 (filed Aug. 5, 2020), the entire contents of which are incorporated by reference herein.

FIG. 3 illustrates additional detail of the transportation matching system 104 determining data collection values and utilizing data collection values to determine transportation values. To illustrate, as shown in FIG. 3, the transportation matching system 104 performs an act 302 of identifying a geofence and determining route locations within the geofence. As shown in FIG. 3, in one or more embodiments, the transportation matching system 104 determines a portion of a route 306 that falls within a geofence 304. To illustrate, the transportation matching system 104 can determine a proportion of the route within a geofence.

Additionally, FIG. 3 illustrates that the transportation matching system 104 performs an act 308 of determining route features. Route features can include a variety of attributes of route locations along a route, including physical features, time, attributes of a corresponding provider device and/or requestor device, and/or various other features. In some embodiments, the transportation matching system 104 weights different considerations. As shown in FIG. 3, the act 308 can include a variety of other acts for determining evaluating route features.

For example, FIG. 3 shows that the act 308 includes an act 310 of comparing route locations and directionality to collected data. In one or more embodiments, the transportation matching system 104 stores collected sensory data and tracks a volume of sensory data corresponding to various locations. In addition to tracking associations between collected sensory data and route locations, the transportation matching system 104 can also track directionality of collected sensory data. That is, the transportation matching system 104 can track the direction from which sensory data was collected. Accordingly, in one or more embodiments, the transportation matching system 104 prioritizes collection of sensory data from different directions at the same route location over collection of sensory data from the same direction.

To illustrate, in one or more embodiments, the transportation matching system 104 can store collected sensory data in a sensory database. In one or more embodiments, the transportation matching system 104 can label collected sensory data with a location and directionality by generating associated metadata. For example, the transportation matching system 104 can store a video clip of an enhanced sensor provider vehicle passing northbound through a particular intersection. Further, the transportation matching system 104 can generate associated metadata labels for the video clip indicating both the intersection (e.g. in coordinates, street names, GPS location, etc.) and the northbound directionality. Thus, the transportation matching system 104 can identify a volume or level of data collected for particular regions, locations, and directions.

Accordingly, the transportation matching system 104 can prioritize sensory data collections for which the transportation matching system 104 has insufficient data. To illustrate, the transportation matching system 104 can compare route locations and route directionality to data in the sensory database. The transportation matching system 104 can determine the volume of data for the route location/directionality in the collected sensory database. The transportation matching system 104 can further determine the data collection value based on the volume of data (e.g., determine a greater data collection value when there is a lower volume of collected data and determine a lower data collection value when there is a higher volume of collected data).

Additionally, the transportation matching system 104 can update the sensory database continuously with newly collected data. Thus, the transportation matching system 104 can reflect collected data in real-time. For example, the transportation matching system 104 can collect data for a particular intersection and update the sensory database accordingly. Accordingly if the transportation matching system 104 receives another transportation request with a route including the same intersection the transportation matching system 104 can update the data collection value based on the most recent volume of collected data. Thus, if the transportation matching system 104 receives additional data for a particular location, route, and/or direction, the transportation matching system 104 can determine a new data collection value based on the sensory data collected (e.g., based on the updated sensory database reflecting the additional collected sensory data).

Accordingly, the transportation matching system 104 can determine a data collection value in part by comparing route locations and the directionality of route locations to collected sensory data. In some embodiments, the transportation matching system 104 determines each route location and a direction for each route location. To illustrate, the transportation matching system 104 can prioritize uncollected or under-collected route locations and uncollected or under-collected directions. More specifically, the transportation matching system 104 can determine a higher data collection value when a route location is not included and/or has limited data in a sensory database. Similarly, the transportation matching system 104 can determine a higher data collection value when directionality for a route location is not included and/or has limited data in the sensory database.

Further, FIG. 3 illustrates that the act 308 includes an act 312 of evaluating time of day. In one or more embodiments, sensory data collection is inefficient or impossible at various times of day. For example, collection of video or images can be inefficient after sunset and before sunrise. Accordingly, in one or more embodiments, the transportation matching system 104 modifies a data collection value based on time of day (e.g., lower value at night, higher value during the day).

In one or more embodiments, the transportation matching system 104 utilizes weather to determine a data collection value. For example, weather can decrease a data collection value if conditions inhibit visibility. Thus, the transportation matching system 104 can assign a lower data collection value for overcast, rainy, or otherwise dark weather. Alternatively, weather can increase value if data regarding certain driving conditions is needed. For example, the transportation matching system 104 can determine that data is absent for rainy conditions and can accordingly increase a data collection value for collection in rainy conditions.

In one or more embodiments, the transportation matching system 104 reduces a data collection value to zero after sundown and before sunset without regard to other route features. In addition, or in the alternative, the transportation matching system 104 reduces data collection values as light conditions improve or worsen. For example, the transportation matching system 104 can determine that a 1.5 hour ride will occur with 45 minutes in daylight, 30 minutes in dusk, and 15 minutes in darkness. For such a ride, the transportation matching system 104 can value the collected sensory value differently for each period of the ride. Accordingly, the transportation matching system 104 can continue to consider the data collection value of non-visual sensory data even when lighting conditions make video or image collection inefficient.

FIG, 3 also shows that the act 308 includes an act 314 of determining prioritized road classification of route locations. In one or more embodiments, the transportation matching system 104 determines various road types, such as highways, freeways, surface streets, one-way streets, access roads, etc. The transportation matching system 104 can determine various priorities for these different road classifications. In one or more embodiments, the transportation matching system 104 categorizes these roads into different priorities. In addition, or in the alternative, the transportation matching system 104 determines a score reflecting a scale for prioritized road classifications.

The transportation matching system 104 can utilize the determined road classifications to generate a data collection value. More specifically, the transportation matching system 104 evaluates road classifications for route locations along a route. Accordingly, in some embodiments, the transportation matching system 104 utilizes the road classifications along a route to determine a data collection value for the route. For example, the transportation matching system 104 can assign a higher data collection value for prioritized road classifications of surface streets, busy intersections, or small alleyways. In another example, the transportation matching system 104 can assign lower data collection values for road classifications of highways, freeways, and expressways.

Also, as illustrated in FIG. 3, the act 308 can include an act 316 of determining route locations and directionality relative to the geofence. As discussed above, the transportation matching system 104 can generate geofences indicating relative priority of different geographical areas. Accordingly, in some embodiments, the transportation matching system 104 determines route locations within geofences. Thus, the transportation matching system 104 can utilize inclusion of route locations in geofences to determine a data collection value for a route. For example, the transportation matching system 104 can assign a higher data collection value for routes including route locations within a geofence. In one or more embodiments, the transportation matching system 104 determines a proportion of a route within a geofence and determines a data collection value based on that proportion, with a greater proportion within a geofence yielding a higher data collection value.

Further, the transportation matching system 104 can determine directionality relative to a geofence. To illustrate, in one or more embodiments, transportation matching system 104 determines whether a route brings an enhanced sensor provider vehicle closer to, into, further away from, or out of a geofence. In some embodiments, the transportation matching system 104 assigns a higher data collection value if a route brings an enhanced sensor provider vehicle closer to or into a geofence and a lower data collection value if a route brings an enhanced sensor provider vehicle further away from or out of a geofence.

In one or more embodiments, the transportation matching system 104 also performs an act 318 of determining a data collection value based on the route features. As mentioned above, the transportation matching system 104 can utilize various route features to determine the data collection value. As shown in FIG. 3, the transportation matching system 104 can input route features 320 into the data collection value model 322 to generate a data collection value 324.

In some embodiments, the transportation matching system 104 utilizes a data collection value model 322 that scores and weights various route features of route locations. For example, the transportation matching system 104 can utilize a heuristic model. In one or more embodiments, the transportation matching system 104 utilizes a heuristic model that assigns data collection values based on route features by determining sub-scores and weights for the various route features. To illustrate, the transportation matching system 104 can determine a sub-score for comparison of route locations to collected data, comparison of route locations to a geofence, time of day, and prioritized road classifications.

For example, the transportation matching system 104 can determine that a route has a sub-score of 90 for comparison of route locations to collected data with a weight of 30%, a sub-score of 80 for comparison of route locations to a geofence with a weight of 30%, a sub-score of 100 for time of day with a weight of 20%, and a sub-score of 75 for prioritized road classifications with a weight of 20%. Thus, the transportation matching system 104 would determine the data collection value as 90(0.3)+80(0.3)+100(0.2)+75(0.2)=86.

Additionally, the transportation matching system 104 can utilize a machine learning model (such as a neural network) data collection value model 322. For example, the transportation matching system 104 can learn which route features or combination of route features are most significant utilizing a variety of supervised learning approaches. The transportation matching system 104 can determine the value of collected data by monitoring what data is used in building a model or by querying users as to which data is most useful. Over time, the system can learn parameters for deciding a data collection values.

In some embodiments, the transportation matching system 104 can utilize a neural network that receives route features as input and generates a corresponding data collection value. In some embodiments, the transportation matching system 104 trains the transportation matching system 104 utilizing route features with corresponding ground-truth data collection values and a loss function. For example, the transportation matching system 104 can utilize a convolutional neural network.

As also shown in FIG. 3, the transportation matching system 104 can also perform an act 326 of utilizing the data collection value to determine a transportation value. In one or more embodiments, the transportation matching system 104 utilizes the data collection value in conjunction with various transportation attributes to determine the transportation value. To illustrate, in some embodiments, the transportation matching system 104 determines transportation values based on predicted wait times, predicted idle times, predicted total transportation times, requestor device data, and provider device data, and other transportation attributes. As mentioned above, the transportation matching system 104 can utilize historical data and data collection values regarding various locations to determine transportation values as described by Sebastien Jean Francois Martin et al., Dispatching Provider Devices Utilizing Multi-Outcome Transportation-Value Metrics And Dynamic Provider Device Modes, U.S. application Ser. No. 16/985,650 (filed Aug. 5, 2020).

In one or more embodiments, the transportation matching system 104 utilizes the transportation scores to determine assignment of a digital transportation request. Accordingly, the transportation matching system 104 assigns digital transportation requests based in part on data collection values. Thus, the transportation matching system 104 determines efficient matches between provider devices and requestor devices based on both efficient transportation and efficient sensory data collection.

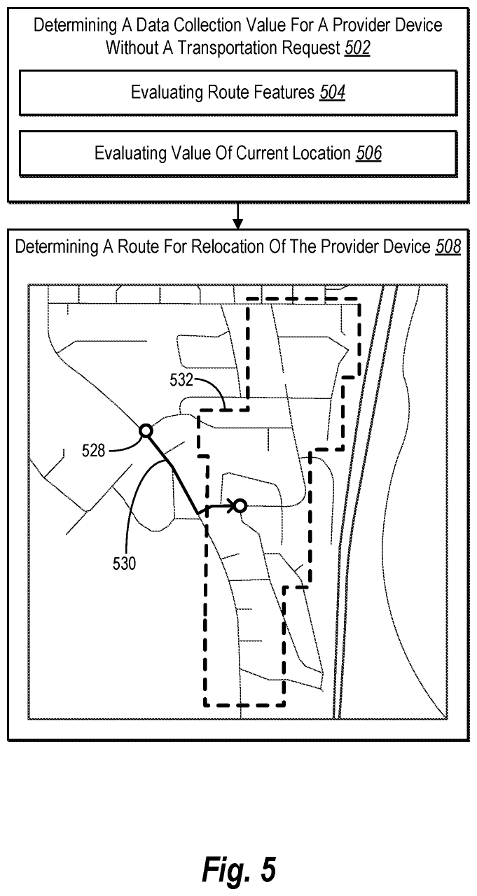

FIG. 3 illustrates determining a data collection value associated with a transportation request. However, in one or more embodiments, the transportation matching system 104 can determine data collection values for various other embodiments. For example, as will be discussed in greater detail below with regard to FIG. 4A, the transportation matching system 104 can use these data collection values to determine a value of a route in selecting a modified route. As discussed in greater detail with regard to FIG. 4B, the transportation matching system 104 can use these data collection values to select an alternate provider device. Moreover, as will be discussed in greater detail with regard to FIG. 5, the transportation matching system 104 can utilize data collection values in determining a modified location for a provider device.

As discussed briefly above, in one or more embodiments, the transportation matching system 104 can utilize data collection values to generate a modified route and/or determine assignment of an alternate provider device. FIG. 4A illustrates additional detail of the transportation matching system 104 modifying routes and matches for digital transportation requests.

As shown in FIG. 4A, the transportation matching system 104 performs an act 402 of generating a route for a digital transportation request and a provider device corresponding to an enhanced sensor provider vehicle. More specifically, the transportation matching system 104 can determine a route from a current location of the provider device to a pick-up location to the digital transportation request and a route to service the digital transportation request from the pick-up location to the drop-off location. In one or more embodiments, the transportation matching system 104 prioritizes low transit time, minimum distance travelled, data collection value, and other transportation concerns at various weights in order to generate the route.

Additionally, as shown in FIG. 4A, the act 402 can include an act 404 of determining a data collection value and overall route value for the route. As discussed in greater detail above with regard to FIG. 3, the transportation matching system 104 generates a data collection value for the route based on a variety of route features, including route locations, route directionality, time of day, prioritized classifications, and/or geofencing.

In one or more embodiments, the transportation matching system 104 utilizes the data collection values to determine route values corresponding to a route for enhanced sensor provider vehicles (or other provider vehicles). Similar to transportation value, the transportation matching system 104 can also utilize a variety of features to determine a route value, including predicted wait times, predicted total transportation times, requestor data, deviation times, deviation distance, etc. In addition, the transportation matching system 104 can utilize data collection value to determine the route value.

To illustrate, the transportation matching system 104 can determine a data collection value of 50 (e.g., based on determining that the selected route is collected during the day, there is a moderate volume of sensory data already collected along the route, and the route is along a highway). In addition, the transportation matching system 104 can analyze the transportation time and distance together with the data collection value to determine an overall route value of 57. As discussed above with regard to transportation value, the transportation matching system 104 can use a weighted combination of the data collection value and other features to determine the route value. In some embodiments, the transportation matching system 104 utilizes a machine learning model to generate the route value based on the data collection value and other route features.

FIG. 4A also shows that the transportation matching system 104 performs an act 406 of determining alternate routes for the transportation request. In some embodiments, the transportation matching system 104 determines alternate routes by generating modified routes with modified/improved data collection values. In one or more embodiments, the transportation matching system 104 generates a modified route by re-generating the route with data collection value as a higher priority (e.g. having a higher weight as a consideration). In addition, or in the alternative, the transportation matching system 104 identifies one or more locations near the route having high priority (e.g. prioritized road classification, uncollected data, etc.) and modifies the route to include the identified locations.

As shown in FIG. 4A, the act 406 can further include an act 408 of determining data collection values and route values for the alternate routes. Similar to the discussion of the act 404 above, the transportation matching system 104 can determine data collection values for each alternate route (e.g., based on different portions within a geofence, different road types, etc.). Moreover, the transportation matching system can determine different route values for the alternate routes based on different transportation features (e.g., different travel times, different travel distances). Thus, the transportation matching system 104 can compare the alternate routes to one another and to the original route based on both data collection values and other transportation features.

In some embodiments, the transportation matching system 104 determines route values for the alternate routes relative to the initial route. For example, the transportation matching system 104 utilizes the initial route (from the act 402) as a baseline and then determines route scores for alternate routes relative to the baseline. Thus, for example, the transportation matching system 104 determines a change in data collection value, a deviation time, a deviation distance, or other changed features and then determines a change in overall route value relative to the initial route.

As shown in FIG. 4A, the transportation matching system 104 also performs an act 410 of comparing data collection and/or route values to select a route. In some embodiments, the transportation matching system 104 compares the alternate routes and the original route and selects the alternate route with the highest route value. For example, if the initial route has a higher route value, than the alternate routes, the transportation matching system 104 selects the initial route (from the act 402). If an alternate route has a higher route value, the transportation matching system 104 selects the alternate route.

Although not illustrated in FIG. 4A, in some embodiments, the transportation matching system 104 utilizes data collection values and transportation values in conjunction with one or more thresholds. For example, in some embodiments, the transportation matching system 104 applies a deviation threshold. To illustrate, the transportation matching system 104 will only select an alternate route if the alternate route deviates (in time and/or distance) from the initial route less than a particular threshold (in time and/or distance). Thus, for example, the transportation matching system 104 will only select an alternate route that is within 2 minutes of travel time (and/or 2 miles of additional distance). Similarly, the transportation matching system 104 can apply a route value improvement threshold (and only select an alternate route if it improves the overall route score by a threshold amount).

As mentioned above, the transportation matching system 104 can also determine whether to pass over an enhanced sensor provider vehicle in matching a transportation request, even if the enhanced sensor provider vehicle has a higher/highest transportation value. Indeed, the transportation matching system 104 can delay dispatch of the provider device based on an anticipated improvement in data collection value from a future transportation request. Specifically, the transportation matching system 104 can determine a threshold (e.g., a threshold delayed dispatch value). If a transportation value fails to satisfy the threshold, the transportation matching system 104 can assign a transportation request to an alternate provider device (even if the enhanced sensor provider device has the highest transportation value). FIG. 4B illustrates a process for utilizing a threshold to assign a transportation request in accordance with one or more embodiments.

As shown in FIG. 4B, the transportation matching system 104 can perform an act 420 of determining a transportation value and a threshold for a digital transportation request. As shown in FIG. 4B, the transportation matching system 104 can process historical data 422 utilizing a delayed dispatch value model 424 to determine a threshold 426. As mentioned above, the transportation matching system 104 can utilize historical data to determine likely value of future transportation requests. For example, the transportation matching system 104 can utilize historical data to determine the probability of a future transportation request with a higher data collection value (and overall transportation value) at a variety of future time increments. The transportation matching system 104 can determine the current total value of the future transportation request (discounted for uncertainty and time) and utilize this value as the threshold. To illustrate, the transportation matching system 104 can utilize historical data to determine likely future transportation requests as described in Sebastien Jean Francois Martin et al., Dispatching Provider Devices Utilizing Multi-Outcome Transportation-Value Metrics And Dynamic Provider Device Modes, U.S. application Ser. No. 16/985,650 (filed Aug. 5, 2020).

In one or more embodiments, the transportation matching system 104 determines data collection values and transportation values for likely future transportation requests. The transportation matching system 104 can utilize these data collection values and transportation values to determine the threshold 426. Additionally, the transportation matching system 104 can determine the threshold 426 for likely future transportation requests based on determined likelihood of receiving the future transportation request, likely amount of time passed between a present time and the receipt of the future transportation request, and other features of the likely future transportation request.

In some embodiments, the transportation matching system 104 can determine the threshold utilizing an alternate approach. For example, the transportation matching system 104 can analyze historical data and determine an average transportation value or data collection value corresponding to enhanced sensor provider vehicles at a particular time and/or location. In some embodiments, the transportation matching system 104 utilizes this average value as the threshold.

As also shown in FIG. 4B, the transportation matching system 104 performs an act 428 of comparing the threshold (e.g., the delayed dispatch value) and the transportation value. In one or more embodiments, the transportation matching system 104 determines which of the transportation value for the present request or the delayed dispatch value is greater. The transportation matching system 104 can utilize this comparison to determine whether to assign an alternate provider device.

As discussed above, the transportation value includes or reflects the data collection value for an enhanced sensor provider vehicle responding to a particular transportation request. Accordingly, comparing the transportation value to the threshold value includes comparing the data collection value to the threshold value (as illustrated by the dashed box in FIG. 4B). In some embodiments, the transportation matching system 104 can compare the data collection value with a data collection threshold (in addition to or in the alternative to comparing a transportation value and transportation value threshold).

As shown in FIG. 4B, the transportation matching system 104 can also perform an act 432 of determining whether to assign an alternate provider device. As discussed briefly above, the transportation matching system 104 can make this determination directly based on a determination of which of the transportation value for the present request or the delayed dispatch value is greater. However, the transportation matching system 104 can also make this determination based on whether the transportation value (and/or data collection value) satisfy the threshold value 426. Specifically, the transportation matching system 104 can assign the enhanced sensor provider vehicle of the transportation value satisfies the threshold value 426 and the transportation value for the enhanced sensor provider vehicle is also highest. Alternatively, the transportation matching system 104 can assign an alternative provider device if the transportation value for the enhanced sensor provider vehicle fails to satisfy the threshold value 426. In such circumstances, the transportation matching system 104 can assign an alternative provider device with the next highest transportation value.

Though FIGS. 4A-4B illustrate separate processes for determining delayed dispatch and determining an alternate route, in one or more embodiments, the transportation matching system 104 utilizes an integrated process. The transportation matching system 104 can apply a variety of collection value thresholds to make these determinations based on data collection values and/or transportation values of various alternate routes. For example, the transportation matching system 104 can utilize a data collection value scale from 0-100. In this example, the transportation matching system 104 sets a collection value threshold for generating a modified route at 80 and a collection value threshold for assigning an alternate provider device at 50. In addition, or in the alternative, the transportation matching system 104 can utilize transportation values for the scale and thresholds.

As described briefly above, the transportation matching system 104 can determine relocation of a provider device without regard to a digital transportation request. FIG. 5 illustrates a process for determining to relocate an enhanced sensor provider vehicle and determining a route for relocation. To illustrate, as shown in FIG. 5, the transportation matching system 104 performs an act 502 of determining a data collection value for a provider device without a transportation request. To illustrate, the transportation matching system 104 determines that, for the overall efficiency of the system, an enhanced sensor provider vehicle should be moved notwithstanding a lack of a transportation request.

To illustrate, as shown in FIG. 5, the act 502 can include an act 504 of evaluating route features. More specifically, the transportation matching system 104 can evaluate features for the current circumstance of the enhanced sensor provider vehicle. Similar to the discussion above in FIG. 3 with regard to evaluating route features for a determined route, the transportation matching system 104 can determine route features for a geographical region.

For example, the transportation matching system 104 can determine route features of the geographical area surrounding a current location of the enhanced sensor provider vehicle. To illustrate, the transportation matching system 104 can determine prioritized route classifications of nearby route locations, compare nearby route locations to geofence(s), and compare nearby route locations to collected sensory data. Additionally, the transportation matching system 104 can determine a current time of day in order to evaluate what sensory data can be collected by the enhanced sensor provider vehicle in the near future.

As also shown in FIG. 5, the act 502 can include an act 506 of evaluating value of the current location. More specifically, the transportation matching system 104 can determine the value of the enhanced sensor provider vehicle remaining in its current location. To illustrate, the transportation matching system 104 can determine the likely value of future digital transportation requests likely to be received near the current location of the enhanced sensor provider vehicle.

In one or more embodiments, the transportation matching system 104 utilizes historical digital transportation request data to predict near-future transportation requests at the geographical region. For example, the transportation matching system 104 identifies similar dates and/or times to the near-future time period at the geographical region. The transportation matching system 104 can utilize calendar information and any received information about the future time period. The transportation matching system 104 can utilize weather, traffic, and/or event information. For example, the transportation matching system 104 can identify previous Thursday mornings as similar to a near-future Thursday night, prior Mother's Day Sundays as similar to a near-future Mother's Day Sunday, and/or can identify a pervious date with a similar event and weather to an event and weather of a near-future date. Thus, the transportation matching system 104 can determine the attributes of digital transportation requests likely to be received in the near-future at the geographical location by determining attributes of past digital transportation requests received at similar dates and times.

Utilizing the determined attributes for digital transportation requests likely to be received in the future, the transportation matching system 104 can determine a value of keeping the enhanced sensor provider vehicle in its current location. In one or more embodiments, the transportation matching system 104 determines a data collection value and/or transportation value for routes corresponding to the digital transportation requests likely to be received in the near-future. In addition, or in the alternative, the transportation matching system 104 can determine an attribute score based on the determined attributes of digital transportation requests likely to be received in the near-future. The transportation matching system 104 can utilize the data collection value, transportation value, and/or attribute value to evaluate a value to the transportation matching system 104 of the current location of the enhanced sensor provider vehicle.

In one or more embodiments, the transportation matching system 104 utilizes a relocation threshold to determine whether to relocate an enhanced sensor provider vehicle. To illustrate, the transportation matching system 104 can determine to relocate an enhanced sensor provider vehicle if the value of the enhanced sensor provider vehicle in its current location does not satisfy a relocation threshold (e.g. is below the threshold). In addition, or in the alternative, the transportation matching system 104 can compare the value of the current location of the enhanced sensor provider vehicle to the value of a relocated enhanced sensor provider vehicle in order to determine whether to relocate the enhanced sensor provider vehicle.

Accordingly, in one or more embodiments, the transportation matching system 104 determines the value to the transportation matching system 104 of the enhanced sensor provider vehicle at an updated location. Additionally, the transportation matching system 104 determines the cost (and data collection value) of relocation of the enhanced sensor provider vehicle. The transportation matching system 104 can determine the overall value of relocating the enhanced sensor provider vehicle to the updated location.

In one or more embodiments, the transportation matching system 104 utilizes costs of relocation relative to value of a corresponding updated location to determine an updated location for the enhanced sensor provider vehicle. To illustrate, similar to the discussion above with regard to evaluating the value of the enhanced sensor provider vehicle at its current location the transportation matching system 104 determines the value to the transportation matching system 104 of the enhanced sensor provider vehicle at various locations. More specifically, the transportation matching system 104 can determine prioritized route classifications of nearby route locations, compare nearby route locations to geofence(s), and compare nearby route locations to collected sensory data. Further, the transportation matching system 104 can determine the cost of time utilized and distance travelled for relocation.

Accordingly, in one or more embodiments, the transportation matching system 104 can compare the relative values and costs of various relocation options to determine the most efficient relocation for the enhanced sensor provider vehicle. Thus, in one or more embodiments, the transportation matching system 104 compares the value of the most efficient relocation to the value of the enhanced sensor provider vehicle at its current location. Accordingly, the transportation matching system 104 can determine whether to relocate the enhanced sensor provider vehicle.

Thus, as shown in FIG. 5, in one or more embodiments, the transportation matching system 104 performs an act 508 of determining a route for relocation of the provider device. As mentioned, the transportation matching system 104 can determine the most efficient final location for relocation of the provider device. As shown in FIG. 3, the transportation matching system 104 determines to relocate an enhanced sensor provider vehicle from outside of a geofence to inside of the geofence. Similar to discussion above with regard to FIG. 4, the transportation matching system 104 generates the route for relocation based on transportation value, data collection value, overall efficiency to the system, etc. Further, the transportation matching system 104 provides navigational instructions for relocation to the provider device associated with the enhanced sensor provider vehicle.

For example, as shown in FIG. 5, the transportation matching system 104 determines that an enhanced sensor provider vehicle at an initial location 510 should be relocated. More specifically, the transportation matching system 104 relocates the enhanced sensor provider vehicle to an updated location inside of a geofence 514. Accordingly, the transportation matching system 104 generates a route 512 for the enhanced sensor provider vehicle to relocate to the updated location. In one or more embodiments, the enhanced sensor provider vehicle collects sensory data during the relocation.

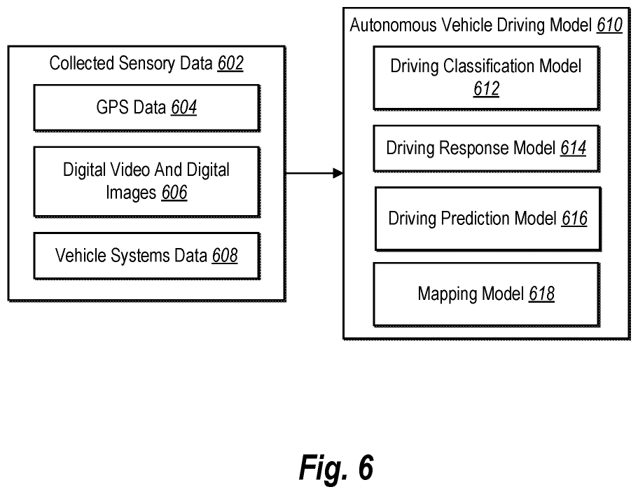

As mentioned previously, the transportation matching system 104 can utilize collected sensory data to build one or more computer-implemented models, including an autonomous vehicle driving model. For example, FIG. 6 illustrates training an autonomous vehicle driving model to navigate an autonomous vehicle utilizing collected sensory data. To illustrate, the transportation matching system 104 can build a mapping model, a driving classification model, a driving response model, and a driving prediction model (or other computer implemented algorithms) of the autonomous vehicle driving model.

As shown in FIG. 6, the transportation matching system 104 processes collected sensory data 602 utilizing an autonomous vehicle driving model 610. As also shown in FIG. 6, the collected sensory data 602 includes GPS data 604, digital video and digital images 606, and vehicle systems data 608. Further, as discussed above, the transportation matching system 104 can utilize collected sensory data further including motion data, proximity sensor data, LIDAR data, RADAR data, and/or other information.

The transportation matching system 104 can utilize the collected sensory data 602 in a variety of ways to build the autonomous vehicle driving model 610. For example, the transportation matching system 104 can utilize the collected sensory data 602 as observation data to provide real-world example driving scenarios to learn from for the autonomous vehicle driving model. In one or more embodiments, the transportation matching system 104 organizes the collected sensory data 602 into scenarios including all available sensory data for a short period of time. Further, the transportation matching system 104 can organize the collected sensory data 602 by building chronological associations between scenarios. Further, the transportation matching system 104 can utilize the collected sensory data to label scenario (and then utilize the labels as ground truths). Thus, the transportation matching system 104 can utilize the collected sensory data as ground-truth data by utilizing a second scenario directly after a first scenario as ground-truth data for the transportation matching system 104.

As shown in FIG. 6, the autonomous vehicle driving model 610 includes a driving classification model 612, a driving response model 614, a driving prediction model 616, and a mapping model 618. In one or more embodiments, each of the driving classification model 612, the driving response model 614, the driving prediction model 616, and the mapping model utilize information and determinations from one another to inform their own determinations. Further, the autonomous vehicle driving model 610 utilizes each of the driving classification model 612, the driving response model 614, and the driving prediction model 616, and the mapping model to navigate autonomous vehicles.

In one or more embodiments, the driving classification model 612 classifies scenarios and/or objects from scenarios. To illustrate, the driving classification model 612 classifies visual objects by type, such as vehicle, pedestrian, or other. In some embodiments, the driving classification model 612 classifies objects into more specific categories as stoplights, crosswalks, bikers, etc. Additionally, the driving classification model 612 identifies and classifies visual objects as stationary or moving. Similarly, the driving classification model 612 can classify a scenario itself, such as driving on a freeway, driving on a local street, stopping at a stop sign, etc. These different scenarios and objects can trigger different reactions, algorithms, or processes.

In some training implementations, the driving classification model 612 generates test classifications. As discussed, in one or more embodiments, the driving classification model 612 generates test classifications for a variety of objects from the collected sensory data 602. In one or more embodiments, the transportation matching system 104 compares the test classifications with ground truth information (from the sensory data) using a loss function.

Additionally, in one or more embodiments, the driving response model 614 determines driving responses. For example, the driving response model 614 determines responses such as steering, braking, accelerating, signaling, lighting, etc. In one or more embodiments, the driving response model 614 generates predicted responses based on the collected sensory data 602.

Further, in some embodiments, the driving prediction model 616 predicts various consequences during navigation of an autonomous vehicle. To illustrate, the driving prediction model 616 predicts both (1) future actions of various objects in the collected sensory data 602, and (2) consequences of actions taken by a vehicle. Accordingly, the driving prediction model 616 can determine consequences of various courses of action during navigation of an autonomous vehicle.

As also shown in FIG. 6, the transportation matching system 104 includes a mapping model 618. The mapping model 618 can include locations of available streets and transportation options. In can also include information regarding routes, roads, or transportation modes, such as signage, speed data (e.g., average, maximum, minimum speeds), intersection labels, etc. In one or more embodiments, the transportation matching system 104 also utilizes collected sensory data to generate and utilize the mapping model 618. Thus, the transportation matching system 104 can utilize the mapping model 618 as part of the autonomous vehicle driving model 610.

More specifically, in one or more embodiments, the transportation matching system 104 utilizes collected sensory data to build maps and map metadata. To illustrate, the transportation matching system 104 can utilize collected sensory data to track navigated streets and build a corresponding map. In one or more embodiments, the transportation matching system 104 can further use visual data to track intersection types, size of streets, etc.

To illustrate, as discussed above, the transportation matching system 104 can dispatch drivers to service transportation requests along routes for collecting sensory data. In one or more embodiments, the transportation matching system 104 can dispatch provider devices and/or enhanced sensor provider vehicles to collect sensory data utilized to generate maps and/or determine map metadata. This data collection can include audio, video, GPS data, sensor data, etc. Thus, as described above in greater detail, the transportation matching system 104 can dispatch drivers and generate routes to collect prioritized sensory data utilizing a data collection value.

Thus, in some embodiments, the transportation matching system 104 builds map metadata utilizing collected sensory data. To illustrate, the transportation matching system 104 can analyze collected sensory data to determine speed limits and/or average moving speeds on various roads. To illustrate, the transportation matching system 104 can utilize GPS data and/or sensor data to determine moving speeds at various locations during data collection along a route.

Further, the transportation matching system 104 can utilize collected sensory data to build information for the map concerning historical traffic conditions, establishments (businesses, parks, etc.) along the route, road maintenance condition, etc. More specifically, the transportation matching system 104 can identify establishments, conditions, and other objects utilizing the autonomous vehicle driving model. Thus, the transportation matching system 104 can label the objects within the map metadata of the mapping model 618.

In one or more embodiments, the transportation matching system 104 utilizes a calculated loss to learn to more accurately navigate an autonomous vehicle. To illustrate, the transportation matching system 104 modifies the parameters of the autonomous vehicle driving model 610 (e.g. internal weights for various layers of autonomous vehicle driving model 610). More specifically, the transportation matching system 104 modifies parameters for each of the driving classification model 612, the driving response model 614, and the driving prediction model 616, and the mapping model based on loss determined by the loss function.

In some embodiments, the transportation matching system 104 utilizes back-propagation techniques to modify these internal parameters of the autonomous vehicle driving model 610 to reduce the loss resulting from application of the loss function. By repeatedly analyzing the collected sensory data 602 and generating predictions, the transportation matching system 104 can train the autonomous vehicle driving model 610 to accurately navigate an autonomous vehicle. Accordingly, in one or more embodiments, the transportation matching system 104 utilizes collected sensory data to train an autonomous vehicle driving model.

As mentioned above, in some embodiments, the transportation matching system 104 utilizes data collection values for other processes. For example, the transportation matching system 104 can utilize data collection values to determine driver transportation zones, combine passenger transportation requests, provide various digital incentives to provider devices, or to generate digital schedules for provider devices.

To illustrate, in some embodiments the transportation matching system 104 can identify driver transportation zones (e.g., Power Zones) with increased rate multipliers (or other incentives) to travel to and service transportation requests within certain geographical areas. The transportation matching system 104 can determine these zones and rate multipliers based on data collection values. For example, if a geographic area has a high data collection value (e.g., a downtown city with very little existing sensory data), the transportation matching system 104 can increase the rate multiplier corresponding to the geographic area. Moreover, the transportation matching system 104 can provide the geographic area and the rate multiplier for display via a provider device. Thus, the transportation matching system 104 can utilize data collection values to identify, determine, and surface driver transportation zones and rate multipliers corresponding to those zones.

Similarly, in assigning multiple transportation requests to a single provider device (e.g., combined rides), the transportation matching system 104 can utilize data collection values. For instance, the transportation matching system can determine a route between two transportation requests. The transportation matching system 104 can determine a data collection value corresponding to the route and add this data collection value to the transportation value for an enhanced sensory vehicle. The transportation matching system 104 can then assign the transportation requests (including the route between the transportation requests) based on the overall transportation value.

In some embodiments, the transportation matching system 104 can provide additional digital incentives to provider devices based on data collection values. For example, the transportation matching system 104 can modify transportation rates based on digital collection values for particular routes and/or transportation requests.

In one or more embodiments, the transportation matching system 104 can determine schedules for enhanced sensor provider devices based on data collection values. For example, the transportation matching system 104 can assign enhanced sensor provider vehicles to particular digital time slots based on a higher data collection value corresponding to the digital time slot.

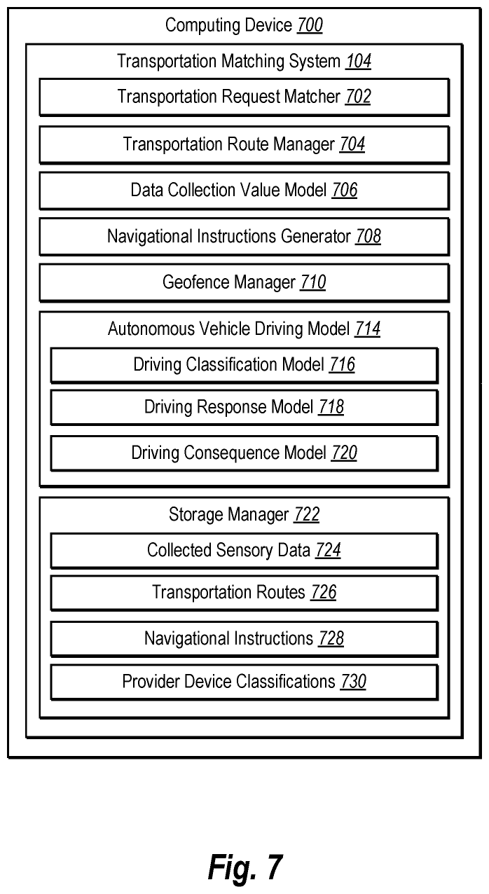

Turning to FIG. 7, additional detail will now be provided regarding various components and capabilities of the transportation matching system 104. In particular, FIG, 7 illustrates an example schematic diagram of the transportation matching system 104 implemented by a computing device 700 (e.g., the server(s) 102, the provider device(s) 106 and/or the requestor device(s) 110) in accordance with one or more embodiments of the present disclosure. As shown, the computing device 700 can implement the transportation matching system 104. Also illustrated, the transportation matching system 104 can include a transportation request matcher 702, a transportation route manager 704, a data collection value model 706, a navigational instructions generator 708, a geofence manager 710, a provider device behavior classifier 712, an autonomous vehicle driving model 714, and a storage manager 722.

As shown in FIG. 7, the computing device 700 includes the transportation request matcher 702. The transportation request matcher 702 assigns transportation requests to provider devices in a pool of available provider devices. In one or more embodiments, the transportation request matcher 702 utilizes transportation values to assign provider devices to transportation requests. In some embodiments, the transportation matching system 104 utilizes transportation values that the transportation matching system 104 determines based in part on data collection values.

Additionally, as shown in FIG. 7, the computing device 700 includes the transportation route manager 704. In one or more embodiments, the transportation route manager 704 generates and modifies transportation routes for provider devices. To illustrate, the transportation route manager 704 determines routes for a provider device to arrive at a pick-up location for a transportation request and for servicing of transportation requests. Further, the transportation route manager 704 can modify routes based on a collection value threshold relative to various values, including data collection values, transportation values, and deviation from a route.

Also, as shown in FIG. 7, the computing device 700 includes the data collection value model 706. In one or more embodiments, the data collection value model 706 determines data collection values. The data collection value model 706 determines data collection values for routes corresponding to enhanced sensor provider vehicles based on various route features. For example, the data collection value model 706 can determine data collection values based on route locations, geofence information, time of day, directionality, previously collected sensory data, etc.

Further, as shown in FIG. 7, the computing device 700 includes the navigational instructions generator 708. In one or more embodiments, the navigational instructions generator 708 generates and provides instructions to provider devices for navigation along determined routes. To illustrate, the navigational instructions generator 708 can generate and provide navigational instructions for servicing a digital transportation request and/or for relocation of a provider device.

Additionally, as shown in FIG. 7, the computing device 700 includes the geofence manager 710. In one or more embodiments, the geofence manager 710 generates and tracks geofences and corresponding data collection priority. In some embodiments, the geofence manager 710 provides geofence information to the data collection value model 706.

Further, as shown in FIG. 7, the computing device 700 includes the autonomous vehicle driving model 714. In one or more embodiments, the transportation matching system 104 builds/trains the autonomous vehicle driving model 714 utilizing collected sensory data. The autonomous vehicle driving model 714 can make various determinations to navigate autonomous vehicles. As shown in FIG. 7, the autonomous vehicle driving model 714 includes a driving classification model 716, a driving response model 718, and a driving prediction model 720. The transportation matching system 104 can build/train other models (e.g., a mapping model or other machine learning models).

Additionally, as shown in FIG. 7, the computing device 700 includes the storage manager 722. The storage manager 722 (e.g., via one or more memory devices) can maintain data of any type, size, or kind, as necessary to perform the functions of the transportation matching system 104, including data received from provider devices and/or requestor devices. For example, as shown in FIG. 7, the data storage 716 can include collected sensory data 724, transportation routes 726, navigational instructions 728, and/or provider device classifications 730.

Each of the components 702-730 of the transportation matching system 104 can include software, hardware, or both. For example, the components 702-730 can include one or more instructions stored on a computer-readable storage medium and executable by processors of one or more computing devices, such as a client device or server device. When executed by the one or more processors, the computer-executable instructions of the transportation matching system 104 702-730 can cause the computing device(s) to perform the methods described herein. Alternatively, the components 702-730 can include hardware, such as a special-purpose processing device to perform a certain function or group of functions. Alternatively, the components ###-### of the transportation matching system 104 can include a combination of computer-executable instructions and hardware.

Furthermore, the components 702-730 of the transportation matching system 104 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 702-730 may be implemented as a stand-alone application, such as a desktop or mobile application. Furthermore, the components 702-730 may be implemented as one or more web-based applications hosted on a remote server. The components 702-730 may also be implemented in a suite of mobile device applications or “apps.”

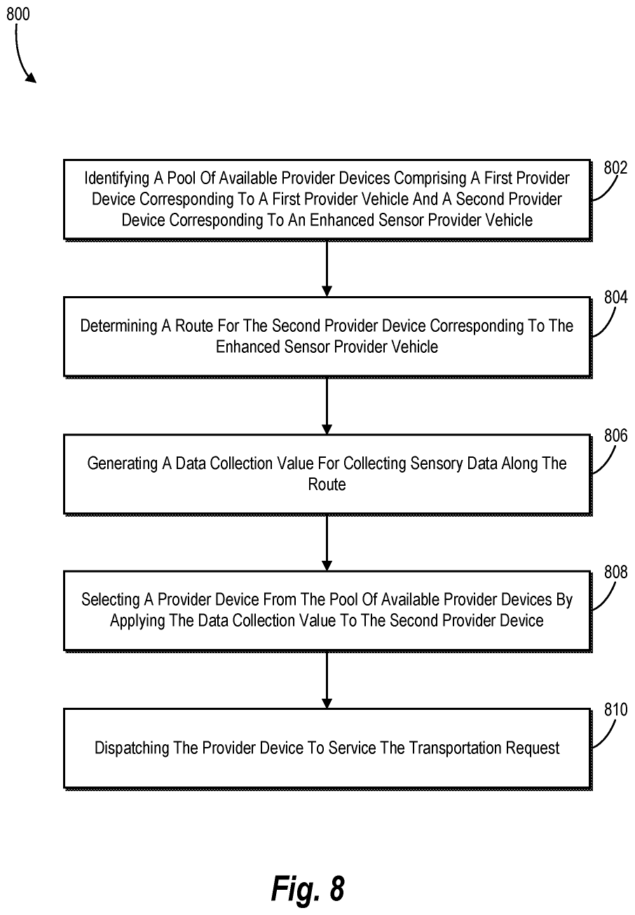

FIGS. 1-7, the corresponding text, and the examples provide a number of different methods, systems, devices, and non-transitory computer-readable media of the transportation matching system 104. In addition to the foregoing, one or more embodiments can also be described in terms of flowcharts comprising acts for accomplishing a particular result, as shown in FIG. 8. FIG. 8 may be performed with more or fewer acts. Further, the acts may be performed in differing orders. Additionally, the acts described herein may be repeated or performed in parallel with one another or parallel with different instances of the same or similar acts.

As mentioned, FIG. 8 illustrates a flowchart of a series of acts 800 for selecting and dispatching a provider device based on a data collection value in accordance with one or more embodiments. While FIG. 8 illustrates acts according to one embodiment, alternative embodiments may omit, add to, reorder, and/or modify any of the acts shown in FIG. 8. The acts of FIG. 8 can be performed as part of a method. Alternatively, a non-transitory computer-readable medium can comprise instructions that, when executed by one or more processors, cause a computing device to perform the acts of FIG. 8. In some embodiments, a system can perform the acts of FIG. 8.

As shown in FIG. 8, the series of acts 800 includes an act 802 for identifying a pool of available provider devices comprising a first provider device corresponding to a first provider vehicle and a second provider device corresponding to an enhanced sensor provider vehicle. In particular, the act 802 can include identifying a pool of available provider devices for servicing a digital transportation request from a requestor device, the pool of available provider devices comprising a first provider device corresponding to a first provider vehicle and a second provider device corresponding to an enhanced sensor provider vehicle.

As shown in FIG. 8, the series of acts 800 includes an act 804 for determining a route for the second provider device corresponding to the enhanced sensor provider vehicle. In particular, the act 804 can include determining a route corresponding to the transportation request for the second provider device corresponding to the enhanced sensor provider vehicle.

As shown in FIG. 8, the series of acts 800 includes an act 806 for generating a data collection value for collecting sensory data along the route. In particular, the act 806 can include generating a data collection value for collecting sensory data along the route utilizing the enhanced sensor provider vehicle. Specifically, the act 806 can include identifying a portion of the route that falls within a data collection geofence and determining the data collection value based on the portion of the route that that falls within the data collection geofence. Additionally, in one or more embodiments, the act 806 includes determining the data collection value based on the at least one of a time of day for collecting the sensory data along the route utilizing the enhanced sensor provider vehicle, or a portion of the route that includes a prioritized road classification.

As shown in FIG. 8, the series of acts 800 includes an act 808 for selecting a provider device from the pool of available provider devices by applying the data collection value to the second provider device. In particular, the act 808 can include selecting, utilizing a device matching algorithm, a provider device from the pool of available provider devices by applying the data collection value to the second provider device. Specifically, the act 808 can include wherein selecting the provider device comprises selecting the second provider device corresponding to the enhanced sensor provider vehicle and dispatching the provider device comprises transmitting the navigational instructions to the second provider device such that the enhanced sensor provider vehicle collects sensory data along the route corresponding to the transportation request. Additionally, the act 808 can include determining a first transportation value for dispatching the first provider device corresponding to the first provider vehicle to service the transportation request, determining a second transportation value for dispatching the second provider device corresponding to the enhanced sensor provider vehicle to service the transportation request based on the data collection value, and comparing the first transportation value and the second transportation value to select the provider device.

In one or more embodiments, the act 808 also includes wherein selecting the provider device comprises selecting the first provider device based on determining that the data collection value fails to satisfy a collection value threshold. Additionally, the act 808 ca include selecting the second provider device corresponding to the enhanced sensor provider vehicle and further comprising generating a modified route that improves the data collection value, and transmitting the modified route to the second provider device such that the enhanced sensor provider vehicle collects sensory data along the modified route.

As shown in FIG. 8, the series of acts 800 includes an act 810 for dispatching the provider device to service the transportation request. In particular, the act 810 can include dispatching the provider device to service the transportation request by transmitting navigational instructions to the provider device.

Additionally, the series of acts 800 can include training an autonomous vehicle driving model utilizing the sensory data collected via the enhanced sensor provider vehicle. Further, in one or more embodiments, the series of acts 800 includes collecting, via the enhanced sensor provider vehicle, sensory data corresponding to the route, and in response to receiving a second transportation request, determining an additional data collection value based on the sensory data collected via the enhanced sensor provider vehicle. Further, in some embodiments, the series of acts 800 includes collecting, via the enhanced sensor provider vehicle, sensory data corresponding to the route, and updating a digital map based on the sensory data.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 9 illustrates a block diagram of an example computing device 900 that may be configured to perform one or more of the processes described above. One will appreciate that one or more computing devices, such as the computing device 900 may represent the computing devices described above (e.g., computing device 800, the server(s) 102, the requestor device(s) 110, the provider device(s) 106, etc.). In one or more embodiments, the computing device 900 may be a mobile device (e.g., a mobile telephone, a smartphone, a PDA, a tablet, a laptop, a camera, a tracker, a watch, a wearable device, etc.). In some embodiments, the computing device 900 may be a non-mobile device (e.g., a desktop computer or another type of client device). Further, the computing device 900 may be a server device that includes cloud-based processing and storage capabilities.

As shown in FIG. 9, the computing device 900 can include one or more processor(s) 902, memory 904, a storage device 906, input/output interfaces 908 (or “I/O interfaces 908”), and a communication interface 910, which may be communicatively coupled by way of a communication infrastructure (e.g., bus 912). While the computing device 900 is shown in FIG. 9, the components illustrated in FIG. 9 are not intended to be limiting. Additional or alternative components may be used in other embodiments. Furthermore, in certain embodiments, the computing device 900 includes fewer components than those shown in FIG. 9. Components of the computing device 900 shown in FIG. 9 will now be described in additional detail.

In particular embodiments, the processor(s) 902 includes hardware for executing instructions, such as those making up a computer program. As an example, and not by way of limitation, to execute instructions, the processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, the storage device 906 can include a non-transitory storage medium described above. The storage device 906 may include a hard disk drive (HDD), flash memory, a Universal Serial Bus (USB) drive or a combination these or other storage devices.

As shown, the computing device 900 includes one or more I/O interfaces 908, which are provided to allow a user to provide input to (such as user strokes), receive output from, and otherwise transfer data to and from the computing device 900. These I/O interfaces 908 may include a mouse, keypad or a keyboard, a touch screen, camera, optical scanner, network interface, modem, other known I/O devices or a combination of such I/O interfaces 908. The touch screen may be activated with a stylus or a finger.

The I/O interfaces 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 908 are configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 provides one or more interfaces for communication (such as, for example, packet-based communication) between the computing device and one or more other computing devices or one or more networks. As an example, and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI. The computing device 900 can further include a bus 912. The bus 912 can include hardware, software, or both that connects components of computing device 900 to each other.

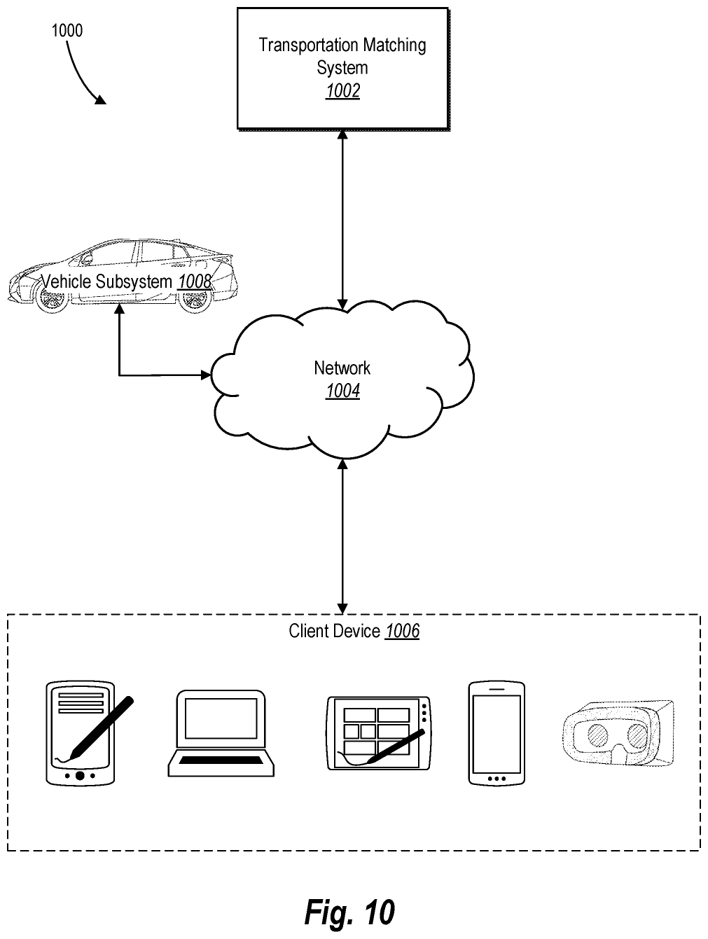

FIG. 10 illustrates an example network environment 1000 of a transportation matching system (e.g., the transportation matching system 104). The network environment 1000 includes a client device 1006, a transportation matching system 1002, and a vehicle subsystem 1008 connected to each other by a network 1004. Although FIG. 10 illustrates a particular arrangement of the client device 1006, the transportation matching system 1002, the vehicle subsystem 1008, and the network 1004, this disclosure contemplates any suitable arrangement of the client device 1006, the transportation matching system 1002, the vehicle subsystem 1008, and the network 1004. As an example, and not by way of limitation, two or more of the client devices 1006, the transportation matching system 1002, and the vehicle subsystem 1008 communicate directly, bypassing the network 1004. As another example, two or more of the client devices 1006, the transportation matching system 1002, and the vehicle subsystem 1008 may be physically or logically co-located with each other in whole or in part. Moreover, although FIG. 10 illustrates a particular number of the client devices 1006, the transportation matching systems 1002, the vehicle subsystems 1008, and the networks 1004, this disclosure contemplates any suitable number of the client devices 1006, the transportation matching systems 1002, the vehicle subsystems 1008, and the networks 1004. As an example, and not by way of limitation, the network environment 1000 may include multiple client devices 1006, the transportation matching systems 1002, the vehicle subsystems 1008, and the networks 1004.

This disclosure contemplates any suitable network 1004. As an example, and not by way of limitation, one or more portions of the network 1004 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. The network 1004 may include one or more networks 1004.

Links may connect the client device 1006, the transportation matching system 1002, and the vehicle subsystem 1008 to the communication network 1004 or to each other. This disclosure contemplates any suitable links. In particular embodiments, one or more links include one or more wireline (such as for example Digital Subscriber Line (DSL) or Data Over Cable Service Interface Specification (DOCSIS), wireless (such as for example Wi-Fi or Worldwide Interoperability for Microwave Access (WiMAX), or optical (such as for example Synchronous Optical Network (SONET) or Synchronous Digital Hierarchy (SDH) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout the network environment 1000. One or more first links may differ in one or more respects from one or more second links.

In particular embodiments, the client device 1006 may be an electronic device including hardware, software, or embedded logic components or a combination of two or more such components and capable of carrying out the appropriate functionalities implemented or supported by the client device 1006. As an example, and not by way of limitation, a client device 1006 may include any of the computing devices discussed above in relation to FIG. 10. A client device 1006 may enable a network user at the client device 1006 to access a network. A client device 1006 may enable its user to communicate with other users at other client devices 1006.

In particular embodiments, the client device 1006 may include a transportation service application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1006 may enter a Uniform Resource Locator (URL) or other address directing the web browser to a particular server (such as server), and the web browser may generate a Hyper Text Transfer Protocol (HTTP) request and communicate the HTTP request to server. The server may accept the HTTP request and communicate to client device 1006 one or more Hyper Text Markup Language (HTML) files responsive to the HTTP request. The client device 1006 may render a webpage based on the HTML files from the server for presentation to the user. This disclosure contemplates any suitable webpage files. As an example, and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the transportation matching system 1002 may be a network-addressable computing system that can host a ride share transportation network. The transportation matching system 1002 may generate, store, receive, and send data, such as, for example, user-profile data, concept-profile data, text data, ride request data, GPS location data, provider data, requestor data, vehicle data, or other suitable data related to the ride share transportation network. This may include authenticating the identity of providers and/or vehicles who are authorized to provide ride services through the transportation matching system 1002. In addition, the transportation service system may manage identities of service requestors such as users/requestors. In particular, the transportation service system may maintain requestor data such as driving/riding histories, personal data, or other user data in addition to navigation and/or traffic management services or other location services (e.g., GPS services).

In particular embodiments, the transportation matching system 1002 may manage ride matching services to connect a user/requestor with a vehicle and/or provider. By managing the ride matching services, the transportation matching system 1002 can manage the distribution and allocation of vehicle subsystem resources and user resources such as GPS location and availability indicators, as described herein.

The transportation matching system 1002 may be accessed by the other components of the network environment 1000 either directly or via network 1004. In particular embodiments, the transportation matching system 1002 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 1002 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1006, or a transportation matching system 1002 to manage, retrieve, modify, add, or delete, the information stored in data store.

In particular embodiments, the transportation matching system 1002 may provide users with the ability to take actions on various types of items or objects, supported by the transportation matching system 1002. As an example, and not by way of limitation, the items and objects may include ride share networks to which users of the transportation matching system 1002 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 1002 or by an external system of a third-party system, which is separate from the transportation matching system 1002 and coupled to the transportation matching system 1002 via a network 1004.

In particular embodiments, the transportation matching system 1002 may be capable of linking a variety of entities. As an example, and not by way of limitation, the transportation matching system 1002 may enable users to interact with each other or other entities, or to allow users to interact with these entities through an application programming interfaces (API) or other communication channels.

In particular embodiments, the transportation matching system 1002 may include a variety of servers, sub-systems, programs, modules, logs, and data stores. In particular embodiments, the transportation matching system 1002 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The transportation matching system 1002 may also include suitable components such as network interfaces, security mechanisms, load balancers, failover servers, management-and-network-operations consoles, other suitable components, or any suitable combination thereof. In particular embodiments, the transportation matching system 1002 may include one or more user-profile stores for storing user profiles. A user profile may include, for example, biographic information, demographic information, behavioral information, social information, or other types of descriptive information, such as work experience, educational history, hobbies or preferences, interests, affinities, or location.

The web server may include a mail server or other messaging functionality for receiving and routing messages between the transportation matching system 1002 and one or more client devices 1006. An action logger may be used to receive communications from a web server about a user's actions on or off the transportation matching system 1002. In conjunction with the action log, a third-party-content-object log may be maintained of user exposures to third-party-content objects. A notification controller may provide information regarding content objects to a client device 1006. Information may be pushed to a client device 1006 as notifications, or information may be pulled from the client device 1006 responsive to a request received from the client device 1006. Authorization servers may be used to enforce one or more privacy settings of the users of the transportation matching system 1002. A privacy setting of a user determines how particular information associated with a user can be shared. The authorization server may allow users to opt in to or opt out of having their actions logged by the transportation matching system 1002 or shared with other systems, such as, for example, by setting appropriate privacy settings. Third-party-content-object stores may be used to store content objects received from third parties. Location stores may be used for storing location information received from the client devices 1006 associated with users.

In addition, the vehicle subsystem 1008 can include a human-operated vehicle or an autonomous vehicle. A provider of a human-operated vehicle can perform maneuvers to pick up, transport, and drop off one or more requestors according to the embodiments described herein. In certain embodiments, the vehicle subsystem 1008 can include an autonomous vehicle—i.e., a vehicle that does not require a human operator. In these embodiments, the vehicle subsystem 1008 can perform maneuvers, communicate, and otherwise function without the aid of a human provider, in accordance with available technology.

In particular embodiments, the vehicle subsystem 1008 may include one or more sensors incorporated therein or associated thereto. For example, sensor(s) can be mounted on the top of the vehicle subsystem 1008 or else can be located within the interior of the vehicle subsystem 1008. In certain embodiments, the sensor(s) can be located in multiple areas at once i.e., split up throughout the vehicle subsystem 1008 so that different components of the sensor(s) can be placed in different locations in accordance with optimal operation of the sensor(s). In these embodiments, the sensor(s) can include a LIDAR sensor and an inertial measurement unit (IMU) including one or more accelerometers, one or more gyroscopes, and one or more magnetometers. The sensor suite can additionally or alternatively include a wireless IMU (WIMU), one or more cameras, one or more microphones, or other sensors or data input devices capable of receiving and/or recording information relating to navigating a route to pick up, transport, and/or drop off a requestor.

In particular embodiments, the vehicle subsystem 1008 may include a communication device capable of communicating with the client device 1006 and/or the transportation matching system 1002. For example, the vehicle subsystem 1008 can include an on-board computing device communicatively linked to the network 1004 to transmit and receive data such as GPS location information, sensor-related information, requestor location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders.

Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
identifying a pool of available provider devices for servicing a digital transportation request from a requestor device, the pool of available provider devices comprising a first provider device corresponding to a first provider vehicle and a second provider device corresponding to an enhanced sensor provider vehicle;
determining a route corresponding to the transportation request for the second provider device corresponding to the enhanced sensor provider vehicle;
generating a data collection value for collecting sensory data along the route utilizing the enhanced sensor provider vehicle;
selecting, utilizing a device matching algorithm, a provider device from the pool of available provider devices by applying the data collection value to the second provider device; and
dispatching the provider device to service the transportation request by transmitting navigational instructions to the provider device.

2. The method of claim 1, wherein:
selecting the provider device comprises selecting the second provider device corresponding to the enhanced sensor provider vehicle; and
dispatching the provider device comprises transmitting the navigational instructions to the second provider device such that the enhanced sensor provider vehicle collects sensory data along the route corresponding to the transportation request.

3. The method of claim 2, further comprising training an autonomous vehicle driving model utilizing the sensory data collected via the enhanced sensor provider vehicle.

4. The method of claim 1, further comprising:
identifying a portion of the route that falls within a data collection geofence; and
determining the data collection value based on the portion of the route that that falls within the data collection geofence.

5. The method of claim 1, further comprising determining the data collection value based on the at least one of:
a time of day for collecting the sensory data along the route utilizing the enhanced sensor provider vehicle, or
a portion of the route that includes a prioritized road classification.

6. The method of claim 1, wherein selecting the provider device utilizing the device matching algorithm comprises:
determining a first transportation value for dispatching the first provider device corresponding to the first provider vehicle to service the transportation request;
determining a second transportation value for dispatching the second provider device corresponding to the enhanced sensor provider vehicle to service the transportation request based on the data collection value; and
comparing the first transportation value and the second transportation value to select the provider device.

7. The method of claim 1, wherein selecting the provider device comprises selecting the first provider device based on determining that the data collection value or a transportation value fails to satisfy a threshold value.

8. The method of claim 1, wherein selecting the provider device comprises selecting the second provider device corresponding to the enhanced sensor provider vehicle and further comprising:
generating a modified route that improves the data collection value; and
transmitting the modified route to the second provider device such that the enhanced sensor provider vehicle collects sensory data along the modified route.

9. The method of claim 1, further comprising:
collecting, via the enhanced sensor provider vehicle, sensory data corresponding to the route; and
in response to receiving a second transportation request, determining an additional data collection value based on the sensory data collected via the enhanced sensor provider vehicle.

10. The method of claim 1, further comprising:
collecting, via the enhanced sensor provider vehicle, sensory data corresponding to the route; and
updating a digital map based on the sensory data.

11. A system comprising:
at least one processor; and
a non-transitory computer-readable medium comprising instructions that, when executed by the at least one processor, cause the system to:
identify a pool of available provider devices for servicing a digital transportation request from a requestor device, the pool of available provider devices comprising a first provider device corresponding to a first provider vehicle and a second provider device corresponding to an enhanced sensor provider vehicle;
determine a route corresponding to the transportation request for the second provider device corresponding to the enhanced sensor provider vehicle;
generate a data collection value for collecting sensory data along the route utilizing the enhanced sensor provider vehicle;
select, utilizing a device matching algorithm, a provider device from the pool of available provider devices by applying the data collection value to the second provider device; and
dispatch the provider device to service the transportation request by transmitting navigational instructions to the provider device.

12. The system of claim 11, further comprising instructions that, when executed by the at least one processor, cause the system to:
select the provider device by selecting the second provider device corresponding to the enhanced sensor provider vehicle;
dispatch the provider device by transmitting the navigational instructions to the second provider device such that the enhanced sensor provider vehicle collects sensory data along the route corresponding to the transportation request; and
train an autonomous vehicle driving model utilizing the sensory data collected via the enhanced sensor provider vehicle.

13. The system of claim 11, further comprising instructions that, when executed by the at least one processor, cause the system to:
identify a portion of the route that falls within a data collection geofence; and
determine the data collection value based on the portion of the route that that falls within the data collection geofence.

14. The system of claim 11, further comprising instructions that, when executed by the at least one processor, cause the system to determine the data collection value based on the at least one of:
a time of day for collecting the sensory data along the route utilizing the enhanced sensor provider vehicle, or a portion of the route that includes a prioritized road classification.

15. The system of claim 11, further comprising instructions that, when executed by the at least one processor, cause the system to select the provider device utilizing the device matching algorithm by:
determining a first transportation value for dispatching the first provider device corresponding to the first provider vehicle to service the transportation request;
determining a second transportation value for dispatching the second provider device corresponding to the enhanced sensor provider vehicle to service the transportation request based on the data collection value; and
comparing the first transportation value and the second transportation value to select the provider device.

16. A non-transitory computer-readable medium comprising instructions that, when executed by at least one processor, cause a computing device to:
identify a pool of available provider devices for servicing a digital transportation request from a requestor device, the pool of available provider devices comprising a first provider device corresponding to a first provider vehicle and a second provider device corresponding to an enhanced sensor provider vehicle;
determine a route corresponding to the transportation request for the second provider device corresponding to the enhanced sensor provider vehicle;
generate a data collection value for collecting sensory data along the route utilizing the enhanced sensor provider vehicle;
select, utilizing a device matching algorithm, a provider device from the pool of available provider devices by applying the data collection value to the second provider device; and
dispatch the provider device to service the transportation request by transmitting navigational instructions to the provider device.

17. The non-transitory computer-readable medium as recited in claim 16, further comprising instructions, that when executed by the at least one processor, cause the computing device to select the provider device by selecting the first provider device based on determining that the data collection value fails to satisfy a threshold value.

18. The non-transitory computer-readable medium as recited in claim 16, wherein selecting the provider device comprises selecting the second provider device corresponding to the enhanced sensor provider vehicle and further comprising instructions, that when executed by the at least one processor, cause the computing device to:
generating a modified route that improves the data collection value; and
transmitting the modified route to the second provider device such that the enhanced sensor provider vehicle collects sensory data along the modified route.

19. The non-transitory computer-readable medium as recited in claim 16, further comprising instructions, that when executed by the at least one processor, cause the computing device to:
collect, via the enhanced sensor provider vehicle, sensory data corresponding to the route; and
in response to receiving a second transportation request, determine an additional data collection value based on the sensory data collected via the enhanced sensor provider vehicle.

20. The non-transitory computer-readable medium as recited in claim 16, further comprising instructions, that when executed by the at least one processor, cause the computing device to:
collect, via the enhanced sensor provider vehicle, sensory data corresponding to the route; and
update a digital map based on the sensory data.
